(19) United States
(12) Patent Application Publication
(10) Pub. No.: US 2026/0181525 A1
(43) Pub. Date: Jun. 25, 2026

(54) METHODS FOR DEVICES WITH MULTIPLE UES

(71) Applicant: InterDigital Patent Holdings, Inc., Wilmington, DE (US)

(72) Inventors: Rocco DiGirolamo, Laval (CA); Anuj Sethi, Ottawa (CA); Samir Ferdi, Kirkland (CA); Michael Starsinic, Newtown, PA (US); Magurawalage Chathura Madhusanka Sarathchandra, London (GB); Taimoor Abbas, Sainte-Julie (CA); Xavier De Foy, Kirkland (CA)

(73) Assignee: InterDigital Patent Holdings, Inc., Wilmington, DE (US)

(21) Appl. No.: 18/989,838

(22) Filed: Dec. 20, 2024

(51) Int. Cl. H04W 40/34; H04W 8/20; H04W 60/04; H04W 76/15; H04W 84/04

(52) U.S. Cl. CPC H04W 40/34; H04W 8/20; H04W 60/04; H04W 76/15; H04W 84/042

(57) ABSTRACT

Methods and devices are disclosed for a wireless transmit receive unit (WTRU) having a first universal integrated circuit card (UICC) and a second UICC, enabling a Multi-UE mode. In one method a WTRU retrieves subscription profile IDs from the first UICC and the second UICC and based on the retrieved subscription profile IDs, the WTRU determine it supports a multi-UE mode of operation using a first UE (UE1) and a second UE (UE2) to operate for mobility between inter-radio access technologies (RAT) networks. In an example, the WTRU establishes, by the UE1 with a first radio access network (RAN) node, a first user plane (UP) path and establishing a multi-UE packet data unit (PDU) session having multi-UE mode rules to switch traffic between UE1 and UE2 with the inter-RAT networks based on occurrence of a triggering event. Additional embodiment are disclosed.

### BACKGROUND

A device that has multiple universal integrated circuit cards (UICCs) can be treated as a device with multiple user equipments (UEs). In previous efforts, each of these UEs behaved, for the most part, independently. For example, each UE in the device performed a public land mobile network (PLMN) search, where each UE registered to its selected PLMN, etc. In cases when the device had limitations with simultaneous operation of the multiple UEs, there was some minimal coordination within the device. The device operated as a multiple universal subscriber identity module (MUSIM) device. In previous efforts, the UEs of a MUSIM device performed independent non-access stratum (NAS) procedures. As both UEs of the MUSIM device are collocated, this resulted in some redundant signaling procedures. For example, in some cases, both UEs of the MUSIM device would inform the network about a change in a tracking area.

In previous releases of the third generation partnership program (3GPP) standards, interworking mobility (namely 4G to 5G mobility) did not rely on a device's multiple UE capability. Rather, interworking mobility was handled by using a new inter-radio access technology (RAT) network interface (e.g. N26 interface) or by using the multi-RAT capability of a device. These solutions are not ideal as the use of multi-RAT required a packet data unit (PDU) session handover, and resulted in a small service interruption. This service interruption could be reduced by using the N26 interface, but the N26 interface is optional, and thus not all operators have deployed this interface.

In 3GPP Release 19, there was some consideration to have the two UEs of a DualSteer device cooperate to optimize some control plane signaling. However, these optimizations were rather limited. In particular, for session management and registration management, these optimizations considered having one UE sending control plane signaling for both UEs. However, no consideration was given regarding whether the device could dynamically change operating as a MUSIM device to a DualSteer device (and vice versa). In addition, optimizations for PLMN search and PLMN selection were not considered. As a result, DualSteer devices had an overhead resulting from redundant procedures being executed on both UEs. The DualSteer devices would lead to redundant over-the-air signaling, unnecessary processing at the device, and unnecessary processing in the core network,

It is expected that more and more devices will support multiple UICCs. If these devices rely solely on mechanisms known from 3GPP Release 19, the system will not take full advantage of the multiple UE capabilities of these devices. Namely, the device would only be able to operate as a MUSIM device or as DualSteer device (not both), and the device could not dynamically change how it is operated. It would be desirable for system enhancements for multiple UEs in a device to be used to enhance service continuity during 5G-6G mobility. Additionally, it would be desirable for a device with multiple UEs to optimize NAS procedures (e.g. PLMN search, PLMN selection, registration management, session management, RAT selection, e.g., between 5G and 6G).

### SUMMARY

According to certain aspects of the disclosure, a device, also referred to as a wireless transmit receive unit (WTRU) is configured to use multiple UEs (UE1 and UE2) to provide service continuity for 5G-6G mobility. It is assumed that UE1 is registered over a first radio access technology (RAT) and UE2 is registered over a second RAT.

In one example aspect, a WTRU including a first UE (UE1) and second UE (UE2) may perform a method where UE1 establishes a first user plane path to a first RAN node of the first RAT network, e.g., 5G network, and UE1 receives measurement configuration for inter-RAT measurements of the second RAT network, e.g., 6G, RAN nodes. In one implementation, the WTRU starts an application that requires service continuity. UE1 establishes a multi-UE PDU session for service continuity, where the multi-UE PDU session contains multi-UE rules to switch traffic based on certain triggering events, e.g., a received signal strength of a second RAN node in the second RAT network or receiving a transfer command from the first RAN node.

According to one example, the UE1 sends application uplink traffic over the first user plane path to the first RAN node and may be triggered to send a measurement report to the first RAN node, indicating that a second RAN node (from the second RAT) has been found. The measurement report is triggered by inter-RAT measurements of the second RAN node on the second RAT. In one implementation, the UE2 receives a service request or paging signal to establish a second user plane path over the second RAN node. The UE1 determines that the signal quality of the second RAN node is better than the signal quality of the first RAN node and switches uplink traffic from UE1 using the first user plane path, to UE2 using the second user plane path. UE1 (or UE2) sends a message to the user plane function (UPF), to indicate to the UPF that the device's downlink traffic should be switched to UE2. The UE2 then sends application uplink traffic over the second user plane path using the second RAN node and receives downlink traffic over the second user plane path using the second RAN node.

In another aspect, a method for a device determination of subscription type and device mode may include a device capable of supporting multiple UICCs. The device has a first UICC inserted and has retrieved the Subscription Profile ID from the first UICC. The device triggers a subscription type determination procedure (e.g. determines that a second UICC has been activated or inserted). The device retrieves the Subscription Profile ID from the second UICC, determines that the two Subscription Profile IDs are the same and that the subscriptions are linked, allowing the device to switch, steer, split, and/or duplicate traffic across multiple UEs.

In one example, the device determines a first device mode (e.g. Single Access device mode) based on a Device Mode Policy, and activates a first UICC and first combination of high-layer functionality/low-layer functionality/radio-transceiver functionality. The device may trigger a dynamic change to a second device mode (e.g. Multi-UE device mode), based on, e.g., known deployment, neighbor relations, request from network, request from RAN node, start/stop of an application. The device may notify the network about a change in device mode. The WTRU then activates a second UICC and second combination of high-layer functionality/low-layer functionality/radio-transceiver functionality. Additional aspects of this solution include the contents of the Device Mode Policy and how it is received by the device.

In yet another aspect of the disclosure, a method for public land mobile network (PLMN) search/selection for a WTRU in Multi-UE device mode is described. A WTRU is configured for Multi-UE device mode (i.e. capable of using multiple UEs). The WTRU is configured to use multiple UEs (UE1 and UE2) in a method where the WTRU retrieves the PLMN lists from each of the UICCs. The WTRU determines, for each UICC, the PLMN/access technology/frequency band to perform the PLMN search. This mechanism may be optimized based on, e.g., PLMN lists, prioritized RAT technology.

Based on the determination, the WTRU configures UE1 with a first combination of high-layer functionality/low-layer functionality/radio-transceiver functionality, and initiates PLMN search for UE1. The WTRU also configures UE2 with a second combination of high-layer functionality/low-layer functionality/radio-transceiver functionality, and initiates PLMN search for UE2. UE1 finds and selects a first PLMN, and UE1 sends a registration request to the first PLMN. UE1 receives a registration response message that includes Multi-UICC assistance information (for example, indication to stop PLMN search for UE2) and UE2 stops its PLMN search.

In a further aspect of the disclosure, a method for PDU Session Establishment for a WTRU in Multi-UE device mode is described. A WTRU is configured for Multi-UE device mode (i.e. capable of using multiple UEs). The device is configured to use multiple UEs (UE1 and UE2). It is assumed that UE1 is registered over a first radio access technology (RAT) and UE2 is registered over a second RAT. In an example method, the WTRU starts a first application and determines the PDU session type is Single Access. The determination may based on the route selection policy that has enhanced PDU session information. The WTRU selects between UE1 and UE2 to establish the PDU session, based on PDU session information (for example based on an application's preferred core network). The WTRU starts a second application and determines the PDU session type is Multi-UE. The determination may be based on the route selection policy that has enhanced PDU session information. Next, the WTRU sends a PDU session establishment request using both UE1 and UE2 and the WTRU receives the PDU session establishment response over both UEs. The response includes Multi-UE rules or activates pre-configured Multi-UE rules. The Multi-UE rules are enhanced to provide new steering, switching, splitting, duplication (SSSD) modes (e.g., based on received signal strength, based on reception of a Transfer command, based on preferred connectivity of the application). Traffic from the second application is then steered, switched, split and/or duplicated based on the Multi-UE rules. Additional aspects of this solution may include: how the Multi-UE rules are received by the device and the granularity of the Multi-UE rules (per service data flow, per PDU session, per UE); contents of the PDU session information; and/or new contents of the PDU session establishment request. Additional aspects, features and/or advantages may become apparent from the description of embodiments which follow.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a functional diagram of an example model of a user equipment (UE);

FIG. 3 is a block diagram showing example options for 4G to 5G migration deployment options;

FIG. 4 is a network diagram showing an example of 4G to 5G standalone interworking mobility;

FIG. 5 is a block diagram showing an example architecture for devices with multiple universal integrated circuit cards (UICCs);

FIG. 6A is a functional block diagram showing a WTRU in single access device mode;

FIG. 6B is a functional block diagram showing a WTRU in a dual connection device mode;

FIG. 6C is a functional block diagram showing a WTRU in a Multi-UE device mode;

FIG. 7A is a network diagram showing potential evolution path for initial 5G>6G deployment with a Multi-UE device mode used for Interworking Mobility;

FIG. 7B is a network diagram showing potential evolution path for maturing 5G>6G deployment with a Multi-UE device mode used for Interworking Mobility;

FIG. 8 is a functional block diagram showing a Multi-UE device mode used for user plane (UP) enhancement;

FIG. 9 is a timing diagram showing a method for a device mode change mechanism according to an example embodiment;

FIG. 10A is a network message diagram of a Multi-UE device mode switching between UEs for Interworking Mobility according to a first example embodiment;

FIG. 10B is a continuation of the network message diagram of FIG. 10A;

FIG. 11A is a network message diagram illustrating a method for using a Multi-UE device mode for Interworking Mobility according to a second example embodiment where the WTRU autonomously chooses to switch between UEs;

FIG. 11B is a network message diagram illustrating a method for using a Multi-UE device mode for Interworking Mobility according to another example embodiment where the network indicates to the WTRU to switch between UEs;

FIG. 12 is a flow diagram of a method for a Multi-UE device to provide service continuity for 5G-6G mobility according to one embodiment;

FIG. 13 is a flow diagram of a method for a device having multiple UICCs to determine subscription type and device mode according to an embodiment; and

FIG. 14 is a flow diagram of a method for public land mobile network (PLMN) search/selection for a WTRU in Multi-UE device mode; and

FIG. 15 is a flow diagram of a method for packet data unit (PDU) session establishment of a WTRU in Multi-UE device mode.

### DETAILED DESCRIPTION

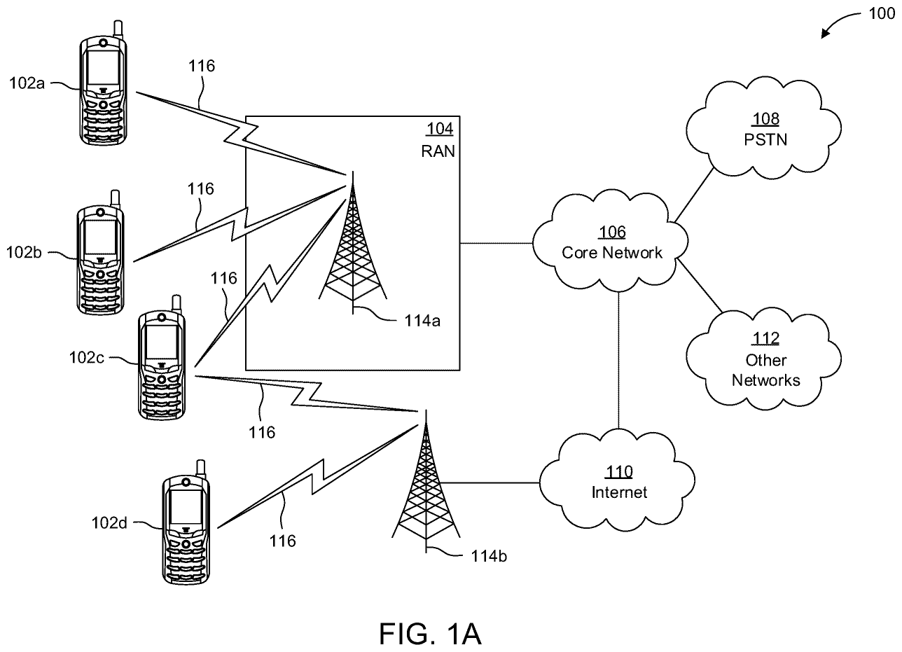

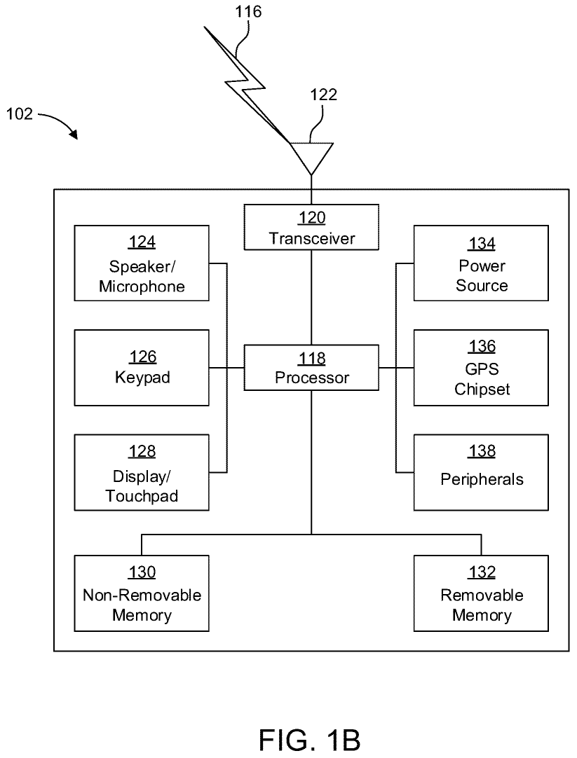

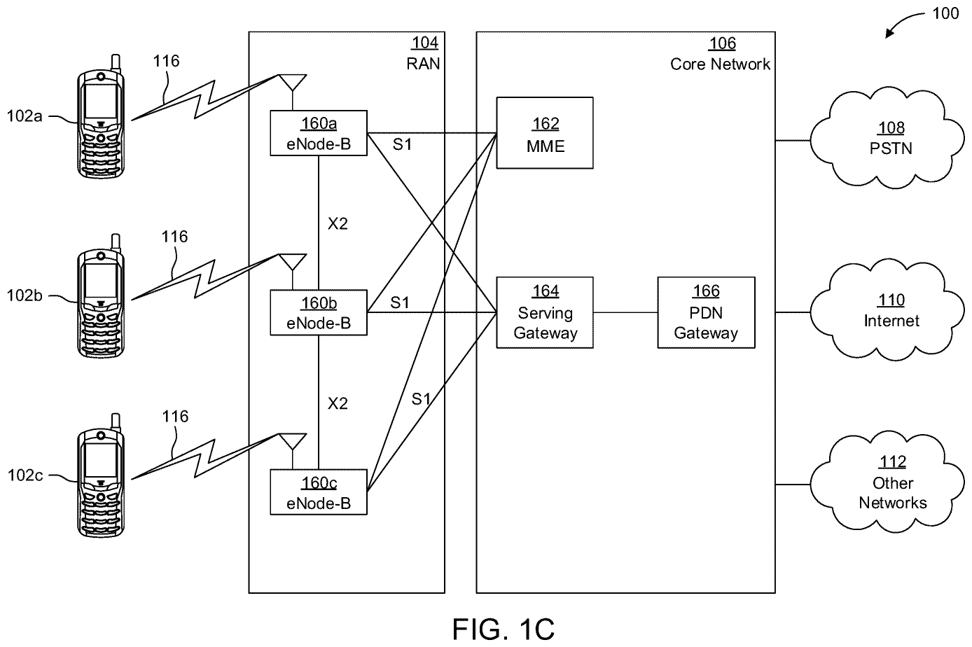

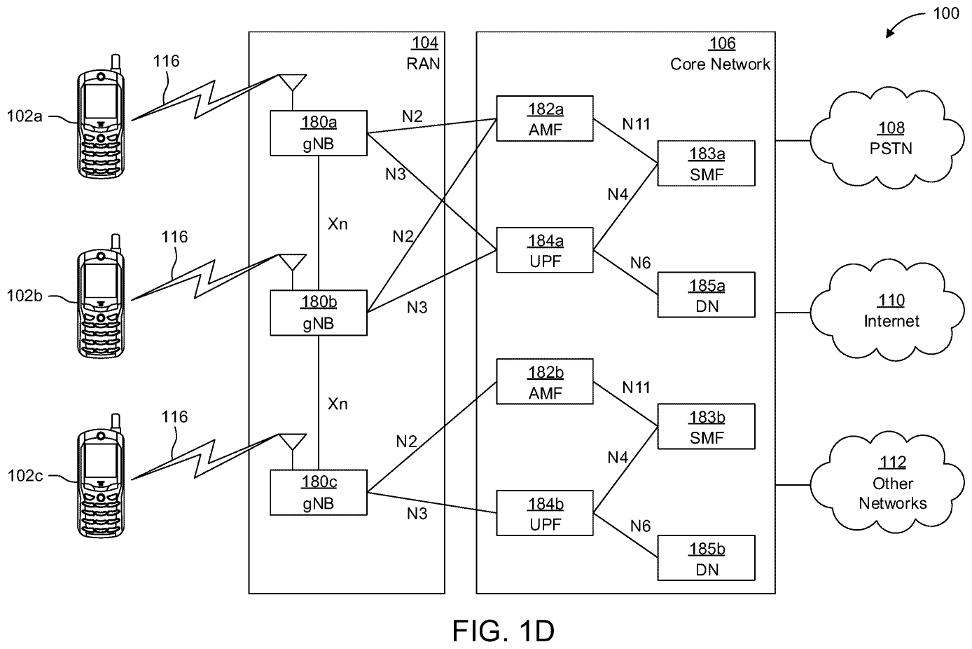

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95(IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11 ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

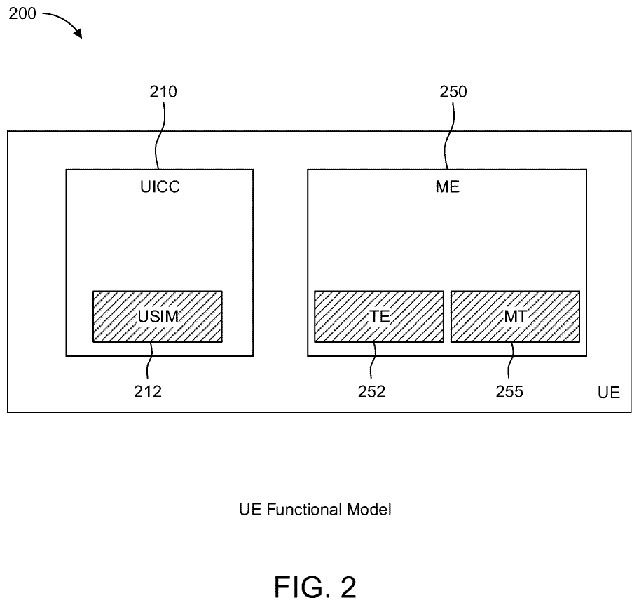

Referring to FIG. 2, the UE model 200 defined by 3GPP is shown. UE model 200 includes a number of sub-components which are defined as follows:
Universal Integrated Circuit Card (UICC) 210: a physically secure device, an IC card (or ‘smart card’), that may be inserted and removed from the terminal or embedded inside the terminal. It may contain one or more applications. One of the applications may be a USIM.
User Services Identity Module (USIM) 212: An application residing on the UICC used for accessing services provided by mobile networks, which the application is able to register on with the appropriate security.
Mobile Equipment (ME) 250: The ME 250 is functionally divided into several entities, i.e. one or more Mobile Terminations (MT) 255 and one or more Terminal Equipments (TE) 252.
Mobile Termination (MT) 255: The MT 255 is the component of the Mobile Equipment (ME) 250 which supports functions specific to management of the PLMN access interface (3GPP or non-3GPP). The MT is realized as a single functional entity.
Terminal Equipment (TE) 252: Equipment that provides the functions necessary for the operation of the access protocols by the user. A functional group on the user side of a user-network interface.

In order to assist public land mobile network (PLMN) selection for 5G networks, the UE performs a PLMN search on all supported radio frequency (RF) channels in the new radio (NR) bands according to its capabilities. On each carrier, the UE will search for the strongest cell and read its system information, in order to find out which PLMN(s) the cell belongs to. This PLMN search is typically done on first power-on of a device, or when camped on a visiting PLMN. The outcome of the PLMN search is a list of available PLMNs and for some of these the signal quality of the PLMN. The UE then prioritizes the list of available PLMNs based on the following order:
(1) Registered PLMN or equivalent PLMN (if it is available) using all access technologies that the UE is capable;
(2) HPLMN (if the EHPLMN list is not present or is empty) or the highest priority EHPLMN that is available (if the EHPLMN list is present);
(3) Each PLMN/access technology combination in the “User Controlled PLMN Selector with Access Technology” data file in the subscriber identity module (SIM) (in priority order);
(4) Each PLMN/access technology combination in the “Operator Controlled PLMN Selector with Access Technology” data file in the SIM (in priority order) or stored in the ME (in priority order);
(5) Other PLMN/access technology combinations with received high quality signal in random order; and
(6) Other PLMN/access technology combinations in order of decreasing signal quality.

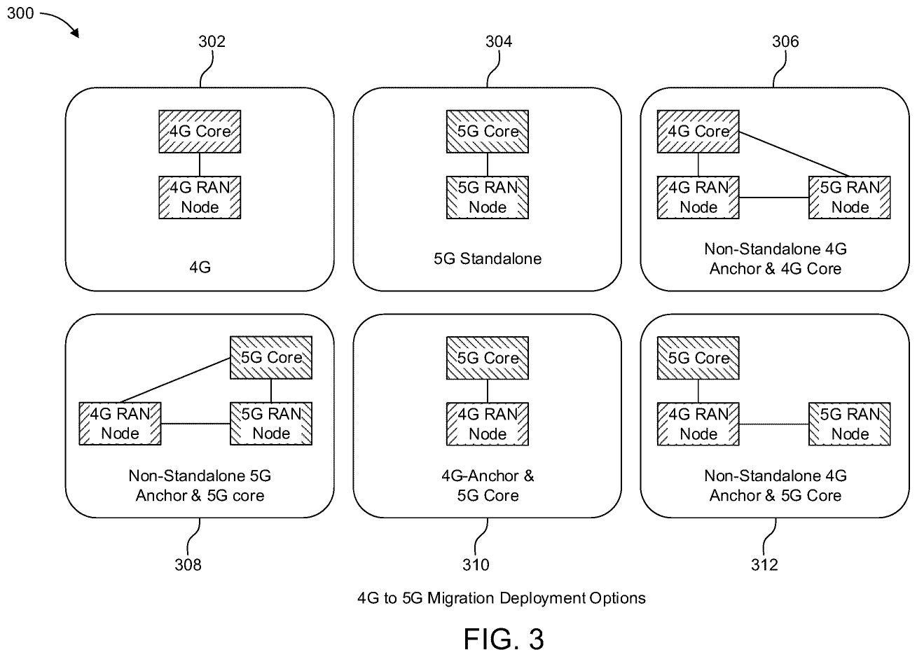

Referring to FIG. 3, diagram 300 shows various 4G to 5G deployment options 302-312. The transition from 4G to 5G led to a number of different deployment options as described below.

In deployment option 302, the UE relies on a 4G RAN node and a 4G core network. This was the legacy LTE architecture. No interworking mobility is possible with deployment option.

In deployment option 304, the UE relies on a 5G RAN node and a 5G core network. This was referred to as Standalone (SA). Interworking mobility is possible but quite complex.

In deployment option 306, the UE relies on Dual Connectivity to a master 4G RAN node and a secondary 5G RAN node, that are both communicating with a 4G core network. This was referred to as Non-Standalone (NSA) and relied on Dual Connectivity. Interworking mobility was possible in deployment option 306, however, the UE could not take advantage of any 5G services offered by the 5G core network, e.g., ultra-reliable low latency communications (URLLC), access traffic steering-switching-splitting (ATSSS), etc.)

In deployment option 308, the UE relies on Dual Connectivity to a master 5G RAN node and a secondary 4G RAN node, that are both communicating with a 5G core network. In this option, the 4G RAN node needed to be enhanced to support communication with the 5G core network.

For deployment option 310, the UE relies on a 4G RAN node communicating with a 5G core network. The 4G RAN node needed to be enhanced to support communication with the 5G core network.

For deployment option 312, the UE relies on Dual Connectivity to a master 4G RAN node and a secondary 5G RAN node, that are both communicating with a 5G core network. In option 312, the 4G RAN node needed to be enhanced to support communication with the 5G core network.

In general, most network operators decided to leverage their existing 4G networks and opted for non-standalone 5G (using deployment option 306). This resulted in a proliferation of UEs that were not fully 5G compliant, i.e., only supporting the 5G NR interface and not the 5G core network. In addition, many of the deployed 5G RAN nodes only supported communication with the 4G core network so these could not be used in deployment option 304. The result was that stand alone 5G deployments were delayed, and UEs could not reap the full benefits of the 5G system (5GS).

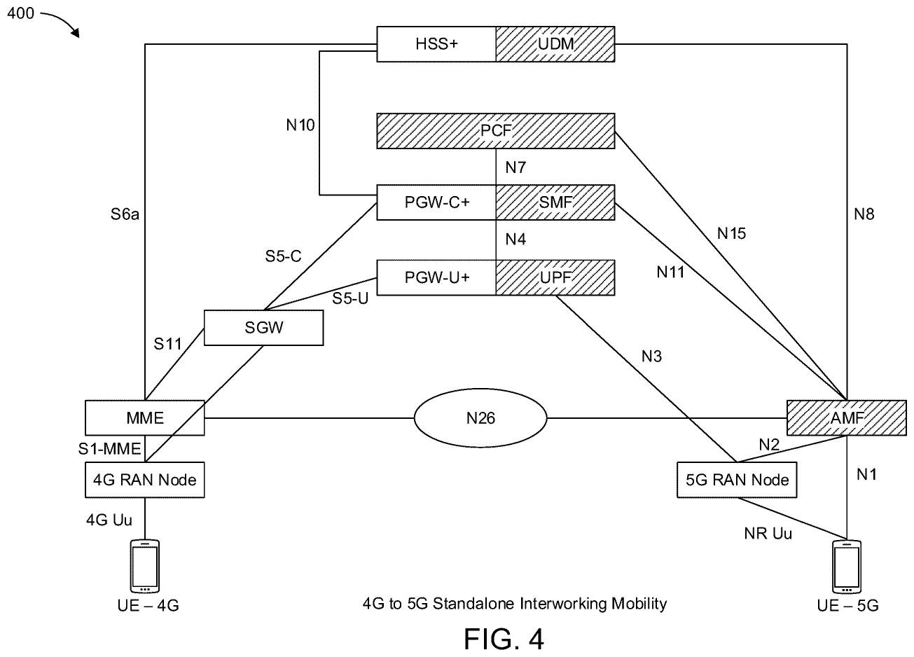

4G to 5G standalone interworking mobility, refers to the 4G to 5G mobility and allows UEs to handover from 4G coverage to 5G coverage and from 5G coverage to 4G coverage. To provide seamless connectivity, two mechanisms were defined. A first mechanism relied on a control plane interface between the 4G core network MME and the 5G core network AMF. This interface is referred to as the N26 interface and allows the 4G core network and the 5G core network to coordinate the handover and share UE context. This N26 interface is shown in FIG. 4 network diagram 400. A second mechanism assumed that the N26 interface was not available, and relied on a UE's Multi-RAT capability to have the UE register simultaneously to the 4G core network over a 4G RAN node and to register to the 5G core network over a 5G RAN node, and then perform a “packet data network (PDN) connection handover” or “protocol data unit (PDU) session handover”. Hereinafter this will be referred to as Interworking with Dual Registration.

A device, also referred to herein as a wireless transmit receive unit (WTRU), with multiple UICCs are now discussed. In 5G, a device may support multiple UICCs and such devices are considered Multi-SIM devices. A Multi-SIM device is a device that behaves as two independent UEs. Each UE independently connects and registers to a network. The networks have no idea that the UEs are part of the same Multi-SIM device. There is some minor coordination in the device to compensate for the case that the device may only transmit and/or receive from a single UE at a time. A Multi-SIM device is capable of steering traffic from a service data flow to one of the two UEs.

In 5G, there was consideration of using a device with multiple UICCs, as a DualSteer device. Such a device is considered to have two linked UEs, where each UE may be connected to a different RAN node and to a different network. The networks are aware that the UEs are part of the same DualSteer device. The device is provided with DualSteer rules that allow the device to steer traffic from a service data flow to one UE, switch traffic from a service data flow from one UE to another UE, split traffic from a service data flow across both UEs, or duplicate traffic from a service data flow across both UEs.

The assumption in 5G was that a device with multiple UICCs can behave as a Multi-SIM device or a DualSteer device, but not both. The device would be pre-configured to know how to behave.

A device that has multiple UICCs can be treated as a device with multiple UEs.

In 3GPP Release 19, each of these UEs behaved, for the most part, independently. For example, each UE performed a PLMN search, each UE registered to its selected PLMN, etc. In cases when the device had limitations with simultaneous operation of the multiple UEs, there was some minimal coordination within the device. The device operated as a Multi-SIM (MUSIM) device.

In 3GPP Release 19, there was also some consideration to use a device with multiple UEs to allow steering traffic of a new application to one of the UEs, to allow splitting traffic from an application across the multiple UEs, to allow switching traffic of an application from one UE to another UE, and to allow duplicating traffic from an application over the multiple UEs. In this context, the device operated as a DualSteer device and was limited to only 2 UEs. A device could be either a MUSIM device or a DualSteer device, but not both. Furthermore, a device could not change from operating as a MUSIM device to a DualSteer device, and vice versa.

As mentioned previously, in 3GPP Release 19, each UE of a MUSIM device performed independent NAS procedures. As both UEs of the MUSIM device are collocated, this resulted in some redundant signaling procedures. For example, in some cases, both UEs of the MUSIM device would inform the network about a change in a tracking area.

Also, for 3GPP Release 19, there was some consideration to have the two UEs of a DualSteer device cooperate to optimize some control plane signaling. However, these optimizations were rather limited. In particular, for session management and registration management, these optimizations considered having one UE sending control plane signaling for both UEs. However, no consideration was given regarding whether the device could dynamically change operating as a MUSIM device to a DualSteer device (and vice versa). In addition, optimizations for PLMN search and PLMN selection were not considered. As a result, DualSteer devices had an overhead resulting from redundant procedures being executed on both UEs. The DualSteer devices would lead to redundant over-the-air signaling, unnecessary processing at the device, and unnecessary processing in the core network,

In 3GPP Release 19, interworking mobility (namely 4G to 5G mobility) did not rely on a device's multiple UE capability. Rather interworking mobility was handled by using a new inter-RAT network interface (e.g. N26 interface) or by using the multi-RAT capability of a device. These solutions were not ideal, since: 1) the use of multi-RAT required a PDU session handover, and resulted in a small service interruption, and 2) the service interruption could be reduced by using the N26 interface, but the N26 interface is optional, and not all operators have deployed this interface.

It is expected that more and more devices will support multiple UICCs. If these devices rely solely on mechanisms known as of 3GPP Release 19, the system will not take full advantage of the multiple UE capabilities of these devices. For example:
(1) The device would only be able to operate as a MUSIM device or as DualSteer device (not both), and the device could not dynamically change how it is operated. How a system may support dynamic change of mode of operation between a MUSIM device or a DualSteer device, to address current pre-configured device behavior is an issue;
(2) The multiple UEs could not be used to enhance service continuity during 5G-6G mobility; and
(3) The multiple UEs could not be used to optimize NAS procedures (e.g. PLMN search, PLMN selection, registration management, session management, RAT selection, e.g., between 5G and 6G).

The embodiments described which follow may address one or more of the foregoing issues.

Common terminology applicable to the disclosed embodiment that follow are now described. In the following, the term RAN node quality refers to some measure of the quality of a RAN node (e.g. received signal quality, received signal strength level, etc.)

In the following, the term Single Access device mode refers to a device mode where a device uses one UE composed of a set of high-layer functionality/low-layer functionality/radio transceiver functionality to communicate with a RAN node.

In the following, the term Dual Connection device mode refers to a device mode where a device uses: 1) one UICC; 2) a 1st set of high-layer functionality/low-layer functionality/radio transceiver functionality to communicate with a master RAN node; and 3) a 2nd set of high-layer functionality/low-layer functionality/radio transceiver functionality to communicate with a secondary RAN node. In this device mode, the device may behave like a single UE with Dual Connectivity or like a single UE with Dual Active Protocol Stack (DAPS). The two RAN nodes have a link (an interface) to allow Dual Connectivity.

In the following, the term Multi-UE device mode refers to a device mode where a device uses 1) a first UE composed of a first UICC and a first set of high-layer functionality/low-layer functionality/radio transceiver functionality to communicate with a 1st RAN node; and 2) a second UE composed of a second UICC and a second set of high-layer functionality/low-layer functionality/radio transceiver functionality to communicate with a 2nd RAN node and so forth for any additional UEs. In this device mode, the device may behave like two UEs or more UEs.

The term legacy network is used to refer to a 5G or earlier network.

The term next generation network and 6G network are used interchangeably and are used to refer to a network beyond 5G.

The term Multi-UE functionality, refers to functionality applicable to a device in Multi-UE device mode, where the subscriptions of the two UICCs of the device are linked, and where the device may switch, steer, split, or duplicate traffic across both UEs.

The terms Multi-USIM functionality and MUSIM functionality are used interchangeably. The terms refer to functionality applicable to a device in Multi-UE device mode, where the subscriptions of the two UICCs of the device are unlinked, and where the device may steer traffic to one of the UEs.

The terms UICC and USIM are used interchangeably, and are used to represent the function that holds the subscription information related to a UE.

The term linked subscriptions, refers to subscriptions of a device, also referred to as a WTRU, with multiple UICCs, where the subscriptions of the device are part of the same subscription profile. The subscriptions are typically to the same operator.

The term unlinked subscriptions, refers to subscriptions of a device with multiple UICCs, where the subscriptions of the device are part of a different subscription profile. The subscriptions are to the same operator or to different operators.

The term Interworking with Dual Registration, refers to a mechanism to provide service continuity on 4G to 5G mobility and on 5G to 4G mobility, that does not rely on the N 26 interface between the 4G core network mobility management entity (MME) and the 5G core network access and mobility management function (AMF).

The term common device functionality, is used to denote higher layer protocol functionality to allow the device to operate over one or more access networks

The term high-layer functionality, refers to functionality of a device that supports parts of the Control Plane (CP) stack and User Plane (UP) stack, needed by the device for communication over an access network. In most cases the parts of the CP stack and UP stack that are part of the high-layer functionality, are implemented in software

The term low-layer functionality refers to functionality of a device that supports the modem processing and radio transmission/reception, needed by the device for communication. In most cases, the low-layer functionality, is implemented in hardware.

The term radio transceiver functionality refers to functionality that supports the receive and transmit radio frequency (RF) front ends, needed by the device for communication. In most cases, the radio transceiver functionality is implemented in hardware.

The term traffic steering refers to the mechanism whereby traffic of a new service data flow is transmitted on one access (or one UE).

The term traffic splitting across multiple accesses refers to the mechanism whereby traffic of a service data flow is dynamically split on one access (or one UE (UE1)) or another access (or another UE (UE2)).

The term traffic switching across multiple accesses refers to the mechanism whereby traffic of a service data flow is moved from one access (or one UE (UE1)) to another access (or to another UE (UE2))

The term traffic duplication across multiple accesses refers to the mechanism whereby traffic of a service data flow is duplicated over both accesses (or over both UE1 and UE2).

The term service is used to refer to an application in the UE.

The term MM_NF refers to a network function in a mobile network that handles mobility management (e.g. mobility registration update procedure). For example, this could be an AMF in the 5G core (5GC), or a new NF in 6GC.

The term SM_NF refers to a network function in a mobile network that handles session management. For example, this could be a session management function (SMF) in the 5GC, or a new NF in 6GC.

The term AM_NF refers to a network function in a mobile network that handles registration management. For example, this could be an AMF in the 5GC, or a new NF in 6GC.

The term PDU Session Information refers to information related to a packet data unit (PDU) session. For example, the data network to provide connectivity with, the network slice to use, whether the PDU sessions requires service continuity, whether the PDU session should be a Multi-UE PDU session, etc.

The term Multi-UE device mode for interworking mobility refers to a mode whereby the two or more UEs of the device are used to enable 5G-to-6G mobility.

The term Multi-UE device mode for user plane enhancement refers to a mode whereby the two or more UEs of the device are used to enable steering traffic over one UE, switching traffic between the two or more UEs, splitting traffic over the two or more UEs, and/or duplicating traffic over the two or more UEs.

The terms operator, mobile operator and PLMN operator are used interchangeably.

The terms access leg, access path, access RAT and access over a RAT are used interchangeably.

In the following, subscription type determination options, refer to methods, options, mechanisms, or procedures that the device may use to determine if the subscriptions of the UICCs are linked or unlinked.

As used herein, device mode selection options, refer to methods, options, mechanisms, or procedures that the device may use to determine which device mode to use (Single Access, Dual Connection, Multi-UE). Dynamic device mode change mechanism, refers to methods, options, mechanisms, or procedures that the device may use to dynamically change the device mode to use (Single Access, Dual Connection, Multi-UE). Subscription linkage information refers to information provided by the network, to assist the device in determining whether the device subscriptions are linked or unlinked.

In the following, the terms FR1, FR2 and FR3, refer to different frequency bands. For example, FR1 refers to frequencies below 7 GHz, FR2 refers to frequencies in the range 24.25 GHz to 71 GHz, FR3 refers to frequencies in the range 7.125 GHz to 24.25 GHz. The use of K1, K2, etc. are used to represent arbitrary constants.

In the following embodiments, it is assumed that:
(1) The 5G system may have services that are not provided by the 6G system. Some PDU sessions may only want to stay in the 5G system. In case the network has to handover a device to a 6G system, these PDU sessions may be released.
(2) The 6G system may have services that are not provided by the 5G system. Some PDU sessions may only want to stay in the 6G system. In case the network has to handover the device to a 5G system, these PDU sessions are released.
(3) The PLMN can have both a 5G core network and a 6G core network.
(4) The next generation device will support multiple high-layer functionality/low-layer functionality/radio transceiver functionality. For example, it may support different high-layer functionality/low-layer functionality/radio transceiver functionality for 5G cellular, 5G satellite, 4G, next generation cellular, next generation satellite. Additionally, the device may have different high-layer functionality/low-layer functionality/radio transceiver functionality for each supported band (e.g. low, mid, high, FR1, FR2, FR3).

To address the shortcomings/inefficiencies of a device/WTRU with multiple UEs, the following system enhancements are desired:
(1) Procedure(s) for the device to determine if the subscriptions associated with the two UICCs are unlinked (meant for MUSIM operation) or linked (meant for Multi-UE operation=DualSteer-like operation)
(2) Procedure(s) for the device to determine a device mode (i.e., Single Access, Dual Connection, Multi-UE). Single Access and Dual Connection are device modes where the device may have multiple UICCs but only one is active and the device operates as a single UE.
(3) Enhanced PLMN search and PLMN selection procedures that take advantage of the multiple UEs
(4) Enhanced Registration procedures that take advantage of the multiple UEs
(5) Enhanced Session Management procedures that take advantage of the multiple UEs. Including new PDU session types, enhanced route selection policy, new Multi-UE rules (these are ATSSS-like rules)
(6) New traffic switching mechanism(s) to provide service continuity in 5G-6G mobility scenarios that rely on the multiple UEs of the device.

The solutions proposed herein may relate to both configuration and use of devices/WTRUs with multiple UICCs and architecture of devices/WTRUs with multiple UICCs.

In the following, example architectures of a device with multiple UICCs are described. A 6G device/WTRU may have multiple Universal Integrated Circuit Cards (UICCs) and may support a layer with a common device functionality, multiple high-layer functionalities, multiple low-layer functionalities, and multiple radio transceiver functionalities.

Each UICC is a physically secure component, an IC card (or ‘smart card’), that may be inserted and removed from the device, or embedded inside the device. The UICC may contain one or more applications, where one of these applications may be a USIM. A single subscription is associated with each UICC and the device with multiple UICCs may have multiple subscriptions, where each subscription may be to the same mobile operator or to different mobile operators. For example, a device with two UICCs will include two subscriptions which may be linked or unlinked. A linked subscription implies that the two subscriptions are part of a single subscription profile that belong to a single operator, although the two subscriptions may also be to two different operators. A linked subscription allows traffic to be steered, switched, split and/or duplicated across multiple access networks. An unlinked subscription implies that the two subscriptions are part of different subscription profiles. An unlinked subscription may be to the same operator, but more likely to different operators. An unlinked subscription allows traffic to be steered across multiple access networks.

Each high-layer functionality supports parts of the Control Plane (CP) stack and User Plane (UP) stack, needed by the device for communication over an access network. In most cases the parts of the CP stack and UP stack that are part of the high-layer functionality, are implemented in software. The high-layer functionality typically operates at the granularity of Protocol or Packet Data Units (PDUs). Examples of protocols that are included in this high-layer functionality include the Non-Access Stratum (NAS), Radio Resource Control (RRC), Service Data Application Protocol (SDAP), Packet Data Convergence Protocol (PDCP), Radio Link Control (RLC), and Media Access Control (MAC).

Each low-layer functionality supports the modem processing and radio transmission/reception, needed by the device for communication. In most cases, the low-layer functionality, is implemented in hardware. The low-layer functionality typically operates at the granularity of bits and includes the baseband signal processing required to transmit and receive over the access networks. Examples of protocols that are included in this low-layer functionality includes the physical (PHY) layer. Each low-layer functionality will typically support a single radio access technology. For example, a device may have a low-layer functionality that supports communication with a non-3GPP node, a low-layer functionality that supports communication with a 5G RAN node, a low-layer functionality that supports communication with a 4G RAN node, and a low-layer functionality that supports communication with a next generation RAN node.

Each radio transceiver functionality supports the receive and transmit radio frequency (RF) front ends, needed by the device for communication. In most cases, the radio transceiver functionality is implemented in hardware. The radio transceiver functionality often includes the antenna and analog processing. Each radio transceiver functionality may be tailored for a specific frequency band. A device may have a radio transceiver functionality that supports very high frequencies and another radio transceiver functionality that supports low frequencies. In addition, a radio transceiver functionality may be tailored for non-terrestrial RANs or terrestrial RANs. For example, a device may have a radio transceiver functionality that supports communication with Geosynchronous (GEO) satellites, a radio transceiver functionality that supports communication with Medium Earth Orbit (MEO) satellites, and another radio transceiver functionality that supports communication with 5G RANs.

The device may additionally have a layer with common device functionality, which has higher layer protocol functionality to allow the device to operate over one or more access networks. In some cases, the common device layer also has the applications used by the device and the Operating System (OS) functionality used by these applications.

Hereinafter, to simplify the description, it will be assumed that the device is limited to two UICCs, although the embodiments are not limited to any particular number greater than two UICCs.

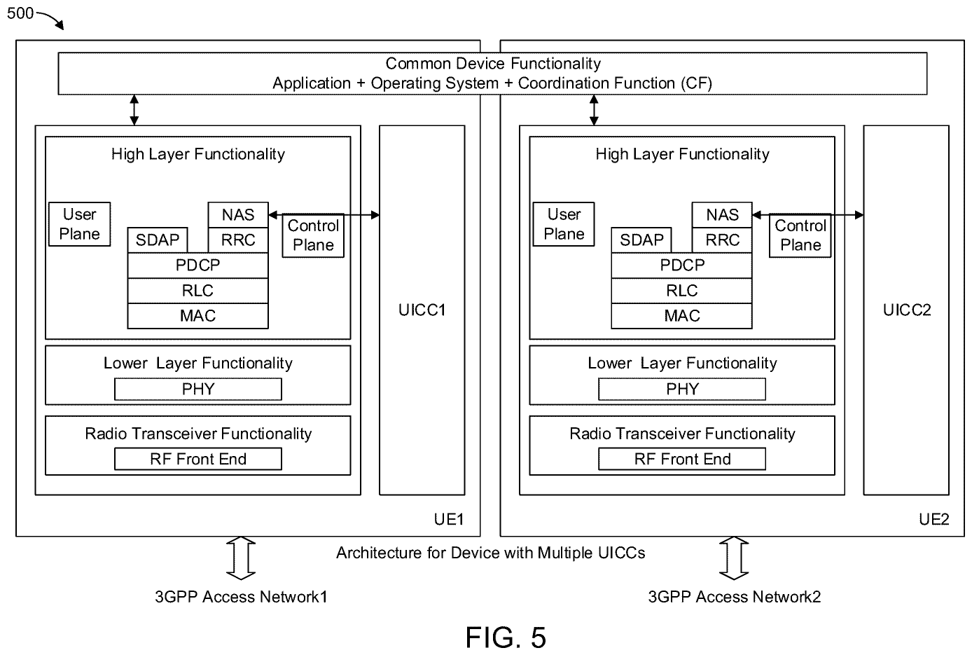

Referring to FIG. 5, one architecture 500 for a device with multiple UICCs is shown. The architecture allows the device to access multiple access networks simultaneously. Which of these blocks are actively involved in a communication over an access network and how the functional blocks pass traffic over (or receive traffic from) the access networks, depend on several factors, including: configuration, deployment, available power, etc.

The high-layer functionalities may exchange information through internal interfaces (not shown in the figure), or alternatively, they may exchange information using the common device functionality (referred to as a “Coordination Function” (CF)). The communication between high-layer functionalities or between a high-layer functionalities and the CF may use (ATtention) AT commands.

Each UICC (UICC1/UICC2) may rely on a combination of high-layer functionality/low-layer functionality/radio transceiver functionality, to obtain services from a PLMN. The resulting combination of high-layer functionality/low-layer functionality/radio transceiver functionality and UICC may be considered a UE and may be identified by a UE identity. For example, the UE identity may be the subscription permanent identifier (SUPI) which belongs to the subscription associated with the UICC. A device that has multiple UICCs may be considered a device with multiple UEs, where each of the UEs may:
(i) support different Radio Access Technologies (RATs) (e.g. 4G, 5G, next generation RAT, satellite, non3GPP); (ii) support different frequency bands; (iii) support different sets of features; and (iv) have different configurations (e.g., network slicing configurations) and policies (e.g., URSP rules) even when they are used to connect to the same mobile network (e.g., PLMN).

The device with multiple UICCs may be identified by a single device identifier (for example like an international mobile equipment identify (IMEI)). Alternatively, if a device with multiple UICCs is considered as a device with multiple UEs, then each UE may have a unique identifier (such as a unique IMEI)

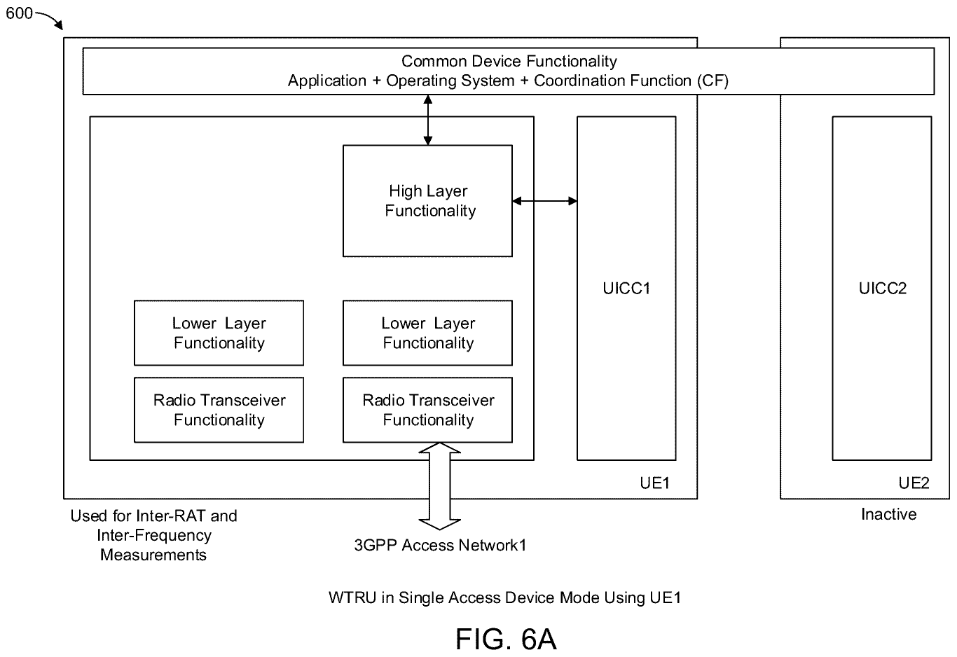

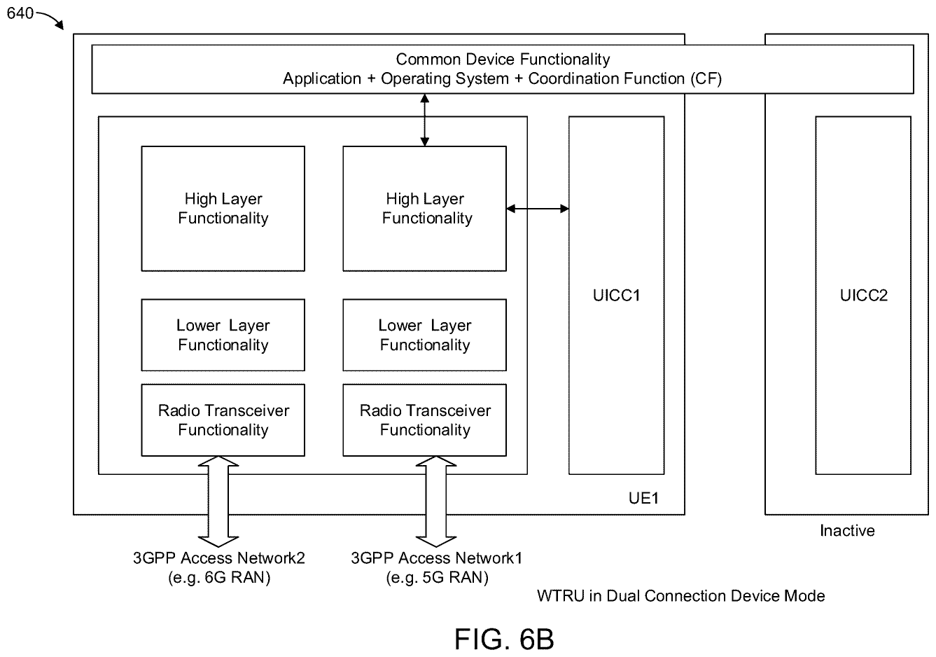

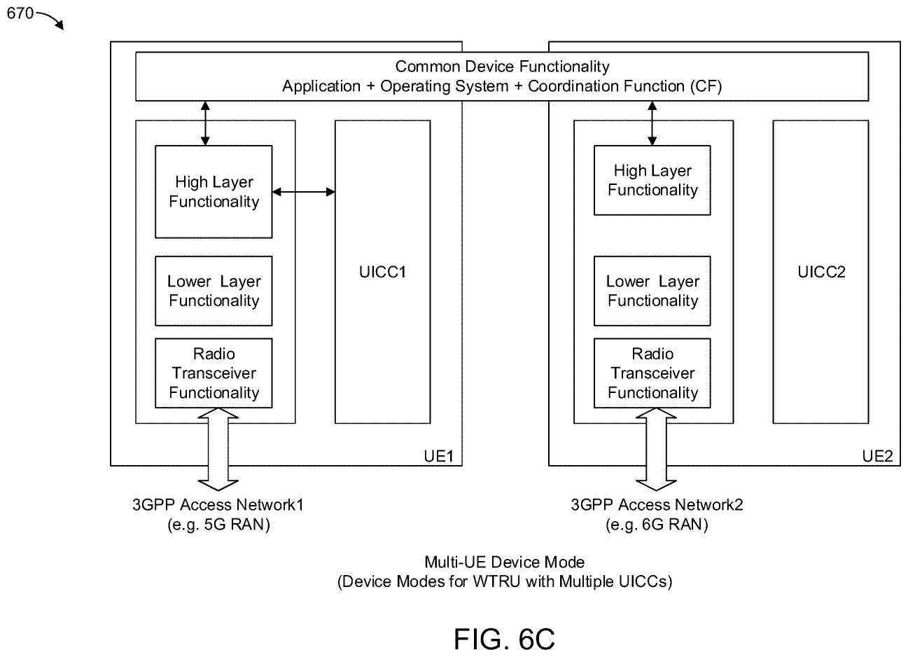

Hereinafter, it will be assumed that the device is limited to two UICCs. Such a device with Dual-UICC may operate in a number of device modes (as shown in FIG. 6)

Referring to FIG. 6A, in a first device mode 600, hereinafter referred to as Single Access device mode (SA DM), the device may have only a single UICC active (e.g., UICC1) as well as a combination of high-layer functionality/low-layer functionality/radio-transceiver functionality, to obtain services from a PLMN. The other functionalities on the device are inactive (e.g. powered down). In this mode, the device behaves like a single UE (UE1). UE1 may access a legacy network or a next generation network. In this device mode, the other functionalities present on the device may be used to assist UE1. For example, the device may need to take inter-RAT measurements and may rely on PHY layer handling of one of the other functionalities to perform these measurements.

Referring to FIG. 6B, in a second mode 640, hereinafter referred to as dual connection device mode (DC DM), the device also relies on a single active UICC (e.g., UICC1). However, in this mode, UICC1 may be associated with multiple high-layer functionalities, low-layer functionalities, and/or radio-transceiver functionalities. In this mode, the device may access two access networks simultaneously. In one option of this mode, one combination of high-layer functionality/low-layer functionality/radio-transceiver functionality accesses a legacy RAN node, and another combination of high-layer functionality/low-layer functionality/radio-transceiver functionality accesses a next-generation RAN node. One RAN node is referred to as a master node, and the other RAN node is referred to as a secondary node. The device typically connects to a single core network. The master node has a control plane connection to the core network. The secondary node has no control plane connection to the core network. This mode may be used for features such as Dual Connectivity (DC), Dual Active Protocol Stack (DAPS), and/or Interworking with Dual Registration.

Downlink traffic may be sent over one or both accesses. The downlink traffic may be split across the two access networks. The splitting may occur at a user plane anchor network function (e.g. UPF), or at one of the RAN nodes. The downlink traffic may be recombined by one of the high-layer functionalities (e.g. at one of the protocol layers such as PDCP or SDAP).

Uplink traffic may be sent over one or both accesses. One of the high-layer functionalities may split the uplink traffic across the two access networks (e.g. at one of the protocol layers, such as PDCP or SDAP). Uplink traffic may be recombined at one of the RAN nodes (e.g. at one of its protocol layers such as PDCP or SDAP).

Referring to FIG. 6C, in a third mode 670, hereinafter referred to as Multi-UE device mode (MU DM), the device has both UICCs active (i.e., UICC1 and UICC2). In this mode UICC1 and UICC2 are each associated with their own combination of high-layer functionality/low-layer functionality/radio-transceiver functionality. In this mode, the device behaves like two UEs. In this mode, the device may access two networks simultaneously. In one option of this mode, one UE accesses a legacy RAN node, and the other UE accesses a next-generation RAN node. Each UE registers over the access network. The UEs may register to the same PLMN, to different PLMNs, and/or to non-public networks (NPNs).

If the subscriptions of the two UICCs are linked, then the device may switch, steer, split, or duplicate traffic across both accesses. Hereinafter, this will be referred to as Multi-UE functionality. If the subscriptions of the two UICCs are not linked, then the device may (e.g. only) steer traffic over one of the accesses. Hereinafter, this will be referred to as MUSIM (or Multi-USIM) functionality.

Downlink traffic may be steered, split, switched, and/or duplicated, on one or both accesses based on Multi-UE Rules contained in the user plane anchor network function (e.g. UPF). The traffic is recombined at the device. For example, the recombining may occur at a higher layer, that is a layer above the high-layer functionality, such as the layer hosting the common device functionality.

Uplink traffic may be steered, split, switched and/or duplicated, on one or both accesses, based on Multi-UE Rules contained in the device. For example, the steering, splitting, switching, duplication may occur at a higher layer (e.g. layers above the high-layer functionality, such as the layer hosting the common device functionality).

A device in Multi-UE device mode may have multiple UEs, but each of the UEs could effectively behave as UE connected to a single RAN node, or as a UE connected in dual connectivity (as long as the device has the capability for it). For example, one UE (e.g., UE1) could be communicating with a RAN node 1, and a second UE (e.g., UE2) could be in dual connectivity with RAN node 1 and RAN node 2.

The device mode provides guidance to the device related to how the CF manages the high-layer functionalities, low-layer functionalities, and/or radio-transceiver functionalities. For example: whether a high-layer functionality should be active, which UE should perform PLMN selection, etc.

Example method using Multi-UE device mode with Multi-UE functionality are now described.

In a first example, a device/WTRU with multiple UICCs, configured to operate in Multi-UE device mode, may be used to enable migration from a 5G network to a next generation network. That is, provide service continuity during mobility between 5G and next generation networks. This is also referred to as interworking mobility. The device will use one of its UEs (e.g. UE1) to connect to the 5G RAN nodes and 5G core network, and another UE (e.g. UE2) to connect to the 6G RAN nodes and 6G core network. As the device enters and leaves areas of 5G coverage and 6G coverage, the device switches traffic between UEs.

The assumption is that operators will not pursue the FIG. 3 migration deployment option 306, to avoid the issues that occurred with the 4G network to 5G network migration. Instead, operators may deploy a 6G core network alongside their 5G core network and will gradually drop in 6G RAN nodes.

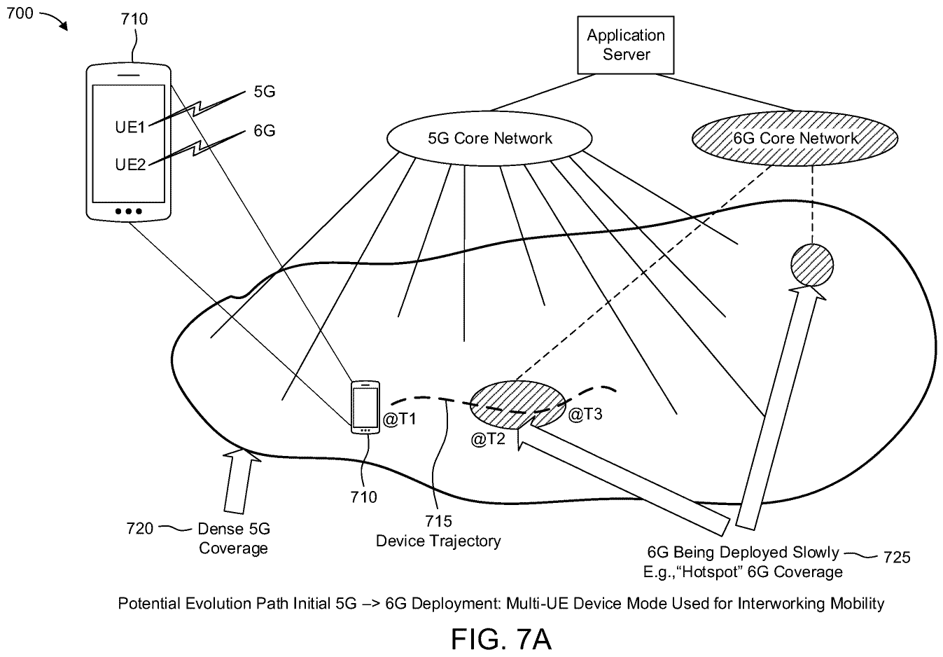

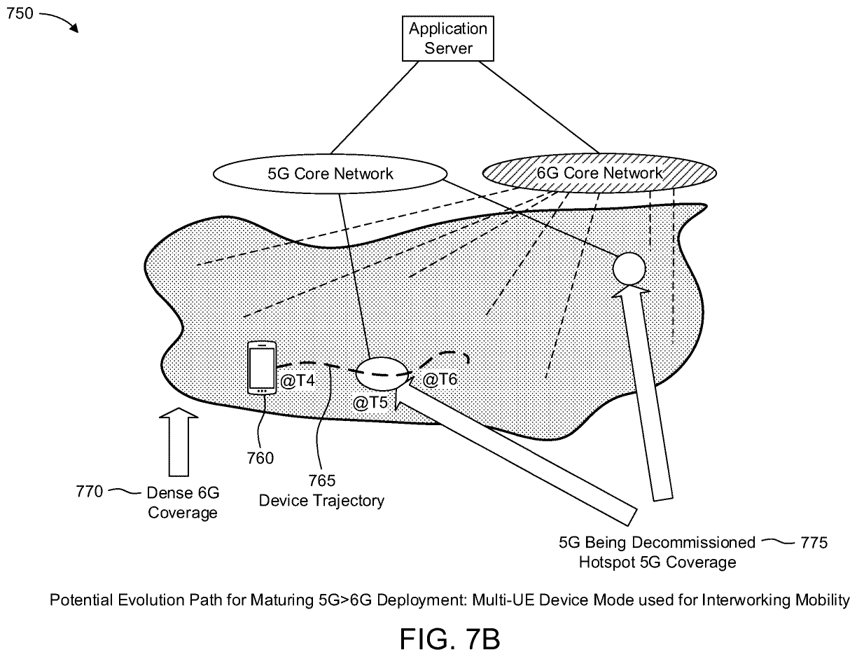

Referring to FIGS. 7A and 7B, a potential evolution path is shown. As an example, a device configured in Multi-UE mode having one UE used for 5G access and one UE used for 6G access. At a first point in time, shown in FIG. 7A diagram 700, a 5G system with a 5G core network along with gNBs provides dense 5G coverage 720. As a first step in FIG. 7A network diagram 700, the operators will deploy a 6G core network, with a few hotspot 6G RAN nodes 725. As a result, there will be significant coverage holes for the 6G network. For example, FIG. 7A shows a device/WTRU 710 with UE1 used for connecting to 5G RAN nodes and a 5G core network, and UE2 used for connecting to 6G RAN nodes 725 and a 6G core network. FIG. 7A shows device 710 traveling along device trajectory 715. At time T1, the device is in an area with no 6G coverage and device will rely on UE1 for connectivity where traffic will be sent via 5G, and UE2 may be inactive. At time T2, the device 710 enters a 6G hotspot 725 and device 710 will switch traffic to UE2 for connectivity where traffic will be sent via 6G, and UE 1 may be inactive. At time T3, the device 710 leaves a 6G hotspot coverage area 725 and device 710 will switch traffic back to UE1 for connectivity, where traffic will be sent via 5G again, and so on.

At a second point in time, as next generation coverage continues to improve, 5G deployments and 6G deployments will co-exist. During this co-existence period, the device may leverage its two UEs to benefit from both the 5G coverage areas and the next generation coverage areas.

At a third point in time, as the operators begin to decommission their 5G network, this will result in 5G coverage holes for the operator. As shown in FIG. 7B diagram 750, as device 760 travels along device trajectory 765, at time T4, the device 760 is in an area where 5G has been decommissioned and device 760 will rely on UE2 for connectivity where traffic will be sent via 6G, and UE1 may be inactive. At time T5, the device 760 enters an area which still has 5G coverage and device may switch traffic to UE1 for connectivity with traffic sent via 5G, and UE2 may be inactive. At time T6, the device leaves 5G coverage 775, and the device will switch traffic back to UE2 for connectivity with traffic sent via 6G again and so on.

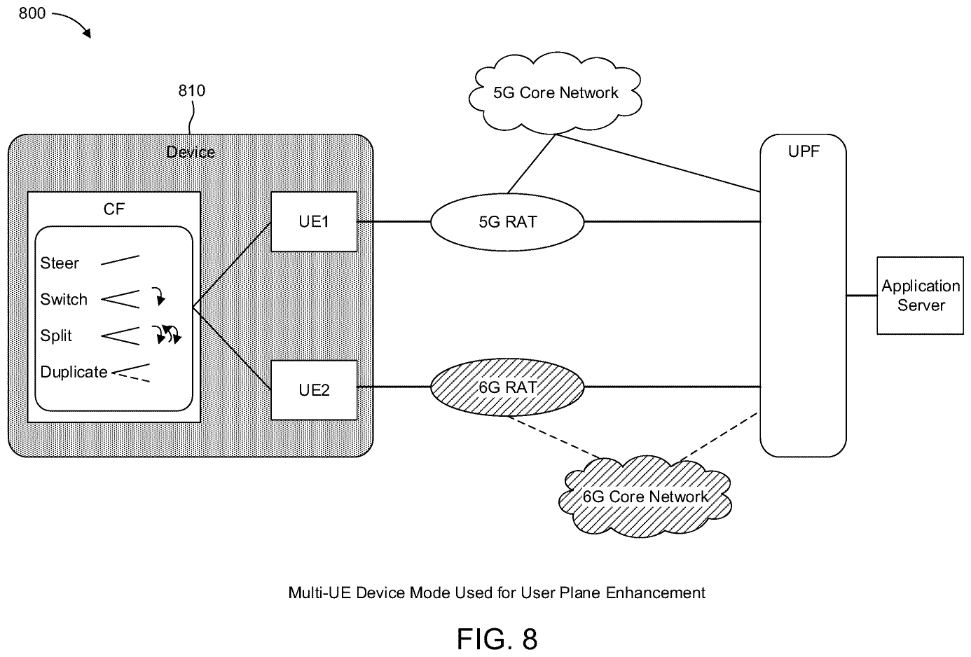

In a second example, a device/WTRU with multiple UICCs, configured to operate in Multi-UE device mode, may be used to provide user plane enhancements. Referring to FIG. 8, an example depiction 800 of a device/WTRU 810 with multiple UICCs configured to operate in Multi-UE device mode is shown, which may be used to provide user plane enhancements. The enhancements may be in terms of reducing delay, reducing loss, increasing throughput, and/or increasing reliability. This Multi-UE device mode provides similar benefits as those provided by ATSSS and DualSteer. That is, the traffic from device 810 may be steered, switched, split, or duplicated between the two UEs (and between the two RATs). For example, if the traffic is not meeting its packet loss requirements, the device 810 may decide to use the Multi-UE device mode to duplicate traffic over the 5G access leg and the 6G access leg. Referring back to FIGS. 7A and 7B, this device mode may be used during the second point in time (co-existence period), when both 6G deployments and 5G deployments co-exist.

The behavior of the device may be different depending on whether the Multi-UE device mode is used for user plane enhancement or interworking mobility. The following procedures may be different, depending on how the Multi-UE device mode is used:
(1) The device may have different rules to decide how to direct traffic over the different access paths. These rules are hereinafter referred to as Multi-UE rules and are described in a subsequent section. The Multi-UE rules may be different depending on whether the Multi-UE device mode is used of user plane enhancements or for interworking mobility
(2) The device may have different PLMN search strategy. For example, if the Multi-UE device mode is used for user plane enhancement, the device may be configured to only search for a second PLMN when the device has applications that require user plane enhancement. If no application requires user plane enhancements, the device may stop the PLMN search for the second PLMN.
(3) The device may have different PLMN selection rules. For example, if the Multi-UE device mode is used for interworking mobility, the device may be configured to always look for 6G RAN nodes. If the Multi-UE device mode is used for user plane enhancements, the device may be configured to look for RAN nodes (5G or 6G) that meet certain minimum performance requirements (e.g. in terms of delay or loss).
(4) The device may have different behavior on receiving a Handover command from a RAN node. For example, if Multi-UE device mode is used for interworking mobility, the reception of a Handover command may trigger a switch of traffic from one UE to another UE. For example, if Multi-UE device mode is used for user plane enhancement, the reception of a Handover command may cause the handover of a UEs traffic from one RAN node to another.

Embodiments for determining whether a type of subscription in a device with Multi-UICCs are linked or unlinked are now discussed. In various scenarios, the device may need to determine whether the types of subscription in each UICC are linked or unlinked. This is needed especially for Multi-UE device mode. If the subscriptions are linked, the device may use the two UEs to steer, switch, split, and/or duplicate traffic over one or both UEs. In contrast, if the subscriptions are not linked, the device may steer traffic to one of the two UEs, but may not switch, split, and/or duplicate traffic over one or both UEs. The determination is based on the UICC of each UE. One or combination of following subscription type determination options may be used to determine type of subscription.

In a first subscription type determination option, upon activation of a UICC, either through manual insertion or through download, the device may check if the subscription belongs to the same home PLMN. For example, each UE may report its home PLMN to the CF. The CF may check that the two home PLMNs match or reported Home PLMNs belong to the equivalent HPLMNs list. If so, the CF decides that the subscriptions are linked. Otherwise, the CF decides that the subscriptions are unlinked. The matching may be extended to all home PLMNs that are equivalent.

In a second subscription type determination option, the UICC may carry an additional identifier, e.g. Subscription Profile identifier that is common to all subscriptions that are linked. Upon activation of a UICC, either through manual insertion or through download, the device may check if the subscription has a subscription profile identifier that matches another subscription. For example, the UE may retrieve the Subscription profile ID from the UICC and report it to the CF. The CF may check that the two UICCs have the same Subscription Profile ID. If so, the CF decides that the subscriptions are linked. Otherwise, the CF decides that the subscriptions are unlinked.

In a third subscription type determination option, the network may provide subscription linkage information to the device, to assist the device in determining whether the two subscriptions are linked or unlinked. For example, this subscription linkage information may an additional identifier associated to each UE, e.g. Subscription Profile identifier. The UE reports the Subscription profile ID to the CF. The CF may check that the two UEs have the same Subscription Profile ID. If so, the CF decides that the subscriptions are linked. Otherwise, the CF decides that the subscriptions are unlinked. As another example, the subscription linkage information may be an indication (e.g., Subscription profile ID with a special value ID) to instruct CF that the subscriptions are not linked. For example, this may be used to override the information stored in the UICC. The device may receive the subscription linkage information as part of a registration. Each UE registers over an access network, and as part of the registration procedure, the network provides the subscription linkage information to each UE. The device may receive the subscription linkage information via other NAS mechanisms, such as UE Configuration Update procedure or UE Parameters Update procedure.

In a fourth subscription type determination option, the user manually configures whether the two UICCs are linked or unlinked. Upon activation of a UICC, either through manual insertion or through download, the user may be prompted (via a graphical user interface) with a list of UICCs present in the device. The list may include an identifier of the UICC, such as an IMSI, ICCID, or SUPI. The user may then use the GUI to select if the UICCs are linked or unlinked.

In each of the subscription type determination options, once the device makes a determination, the device may additionally interact with the network to allow the network to accept or reject the determination, and to enforce the proper policy related to the determination. This may be useful, in cases that the network provides different policies for linked subscription vs unlinked subscriptions. For example, a network may confirm the link determination based on the ID exchanged via the registration. UDM may trigger UE Parameters Update procedure to push updated UICC link determination status to the UEs. The UEs may then forward this information to the CF. The interaction with the network may ensure that two subscriptions can be linked. For example, there may be scenarios where only some subscriptions are allowed to be linked (e.g., an operator may decide that only some subscriptions that belong to a certain category can be linked, ensuring that the user pay extra for linked subscriptions). In such scenarios, the GUI may provide feedback to the user, stating whether the selected subscriptions have been successfully linked or not.

Additional triggers for invoking the subscription type determination may include:
Expiry of a periodic registration timer
On switch-on of a device
On return from lack of coverage
Activation or deactivation of a UICC (removal or insertion of the SIM card, or downloading of a eSIM profile); and/or
Upon a handover, for example from a 5G network to a 6G network.

In the following, mechanisms for the device to determine the device mode (e.g. Single Access, Dual Connection, Multi-UE) are discussed. A device may need to determine the device mode to operate in. Based on the device mode, the device decides which combination of high-layer functionality/low-layer functionality/radio-transceiver functionality to activate and how to perform PLMN search and PLMN selection.

The intent of the device mode is to indicate to the device how to use its multiple UICCs and its multiple high-layer functionality/low-layer functionality/radio transceiver functionality. The assumption is that a device supports all three device modes. Some procedures could be optimized depending on the device mode. For example, if a device determines to operate in Single Access device mode, then the device may save power and processing. Alternatively, if a device determines to operate in Multi-UE device mode, then it could optimize PLMN selection. In various embodiments, the device may make this determination based on one or more of the following device mode selection options.

In a first device mode selection option, a device only has a single UICC installed (or activated). In such cases, on power on or return to service, the device may be (pre)configured to use Single Access device mode.

In a second device mode selection option, a device has two UICCs installed (or activated). In such cases, on power on or return to service, the device may be (pre)configured to use a specific device mode (either Single Access device mode, or Dual Connection device mode, or Multi-UE device mode).

In a third device mode selection option, a device may make the device mode determination using a Device Mode Policy. A device may be pre-configured or provisioned with this Device Mode Policy. The policy tells the device to operate in Single Access device mode, Dual Connection device mode, or Multi-UE device mode. The Device Mode Policy may be stored in a higher layer, such as the common device functionality, for example, in the CF. The policy may be provisioned through control plane signaling from the home PLMN. Alternatively, the policy may be pre-configured in the CF. The Device Mode Policy may be a new policy or a policy included in the URSP rules or QoS rules provided to the device. Based on the Device Mode Policy, the device determines a device mode

The Device Mode Policy may provide an indication to the device to use Multi-UE device mode on power on, or on return to service, or on detection that a second UICC has been inserted or activated. The policy may additionally provide an indication of which UICC is the primary UICC, which UICC is the secondary UICC, whether the Multi-UE device mode should be used for user plane enhancement or interworking mobility.

The Device Mode Policy may provide an indication to the device to use Dual Connection device mode on power on, or on return to service, or on detection that a UICC has been inserted, or on detection that a UICC has been removed. The policy may additionally provide an indication of which combination of high-layer functionality/low-layer functionality/radio-transceiver functionality to use to establish connection to a master node.

The Device Mode Policy may provide an indication to the device to use Single Access device mode on power on, or on return to service, or on detection that a UICC has been inserted, or on detection that a UICC has been removed, or on power on when the device detects that it has a single UICC inserted (or activated), or on return to service when the device detects that it has a single UICC inserted (or activated). The policy may additionally provide an indication of which combination of high-layer functionality/low-layer functionality/radio-transceiver functionality to use for the single access.

In some cases, the device mode may need to be changed dynamically. The device may dynamically change the device mode, using one or a combination of the five dynamic device mode change mechanisms described below.

In a first dynamic device mode change mechanism, the device may autonomously decide to change the device mode based on the operator deployment. The device may receive an indication of the deployment from a RAN node. The RAN node may provide an indication that the deployment supports:
Only 5G RAN nodes;
Only next generation RAN nodes;
Next generation RAN nodes with 5G RAN nodes in dual connectivity mode; and/or
5G RAN nodes with next generation RAN nodes in dual connectivity mode.

For example, if the RAN node provides an indication that the deployment supports only 5G RAN nodes, then the device may determine to use Single Access device mode, and only activate the combination of high-layer functionality/low-layer functionality/radio-transceiver functionality to that supports 5G. The device may deactivate the other high-layer functionalities, low-layer functionalities, and/or radio-transceiver functionalities that do not support 5G.

As another example, if the RAN node provides an indication that the deployment supports 5G RAN nodes with next generation RAN nodes in dual connectivity mode, then the device may determine to use Dual Connection device mode, and activate the combination of high-layer functionality/low-layer functionality/radio-transceiver functionality to that supports 5G as well as the high-layer functionality/low-layer functionality/radio-transceiver functionality to that supports 6G.

Alternatively, the RAN node may provide an indication of the deployment options that are not supported. The RAN node may broadcast this information as part of its system information. Alternatively, this information may be provided via dedicated signaling from the RAN node.

The Device Mode Policy may provide an indication to the device whether to use the first dynamic device mode change mechanism.

In a second dynamic device mode change mechanism, the RAN node provides information related to neighbor cells, and how these cells may be used. For example, say a UE of the device (say UE1) is connected to a RAN node. The RAN node may use a Neighbor Relations Table to configure the device mode. The Neighbor Relations Table maintains an indication on how the neighbor cells may be used—in Single Access device mode, in Dual Connection device mode, or in Multi-UE device mode. If the Neighbor Relations Table is not available or not up to date, the RAN node may rely on an Automatic Neighbor Relation procedure. The RAN node may configure the device to report discovered cells on specific RATs, for example using measurement reports. The RAN node may maintain the discovered RAT information in a Neighbor Relations Table. OAM procedures may then be used to provide an indication on how the neighbor cells may be used - in Single Access device mode, in Dual Connection device mode, or in Multi-UE device mode. The RAN node may make the device mode decision and send the configuration to the device.

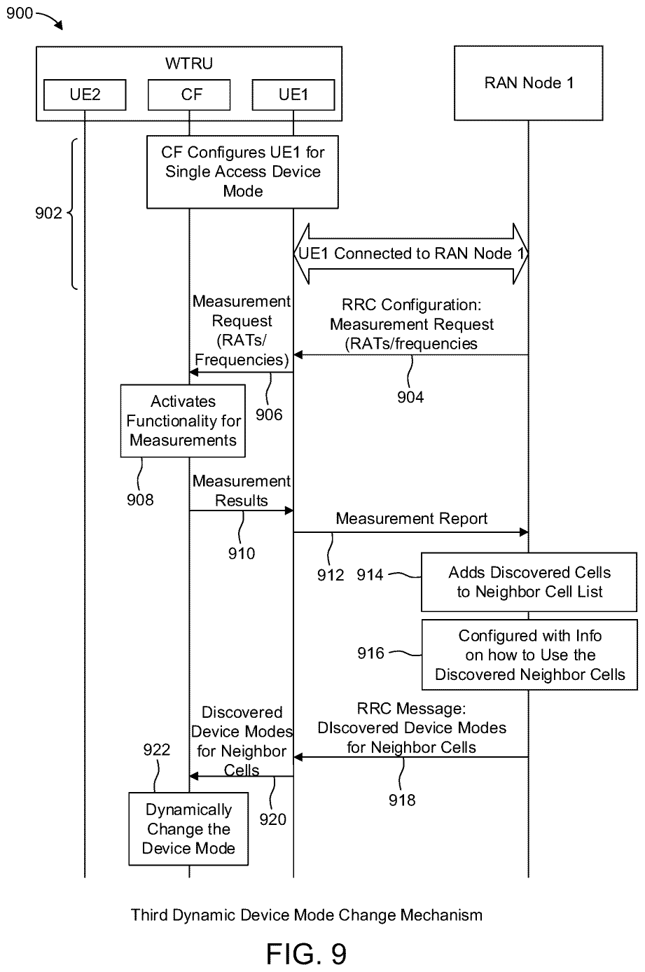

Referring to FIG. 9, an example method 900 is shown for third dynamic device mode change mechanism. Initially, a WTRU in Single Access device mode using a 1st combination of high-layer functionality/low-layer functionality/radio-transceiver functionality (e.g. UE1), and UE1 is connected to a RAN node 1. Entities involved in method 900 include the WTRU and RAN Node 1.

At step 902, the control function (CF) has configured UE1 for Single Access Device Mode and UE1 has connected to RAN Node 1. At step 904, RAN node 1 configures UE1 to measure specific RATs and/or frequencies. For example, this may be through an RRC configuration of measurement reports. RAN node 1 configures UE1 to perform measurements on the other RATs, based on a capability exchange between UE1 and RAN node 1. The capability exchange may provide an indication to RAN node 1 related to the device's capabilities to do measurements on other RATs, e.g., 6G. UE1 may receive the device's capabilities to do measurements on other RATs, from the CF.

At step 906, UE1 informs the CF about the request for inter-RAT and inter-frequency measurements. At step 908, the CF decides to activate a 2nd combination of high-layer functionality/low-layer functionality/radio-transceiver functionality to assist in the inter-RAT and inter-frequency measurements. The 2nd combination of high-layer functionality/low-layer functionality/radio-transceiver functionality provides the inter-RAT measurement results to the CF, which forwards the measurements to UE1 at step 910. UE1 is triggered to send a measurement report to the RAN node 1 at step 912.

At step 914, RAN node 1 adds the discovered RAT information to the Neighbor Relations Table (neighbor cell list). RAN node 1 is configured with information on how to use the discovered neighbor cells at step 916. For example, this may be through some operations, administration and maintenance (OAM) procedure. Interactions related to this OAM procedure are not shown in FIG. 9. A neighbor cell may be configured to be used with multiple device modes (Single Access, Dual Connection, or Multi-UE). Hereinafter, this information will be referred to as discovered device modes for neighbor cells.

Next, RAN node 1 provides the discovered device modes for neighbor cells, to UE1 at step 918. For example, this information may be provided via a RRC message. UE1 provides discovered device modes for neighbor cells, to the CF at step 920. The WTRU (e.g. the CF) may use the discovered device modes for neighbor cells and the Device Mode Policy to dynamically change the device mode at step 922.

In the third dynamic device mode change mechanism, the RAN node may determine to change the device mode and send an explicit indication of the device mode to use: i.e., Single Access, Dual Connection, Multi-UE. The RAN node may broadcast this information as part of its system information. Alternatively, this information may be provided via dedicated signaling from the RAN node. The RAN node may rely on the Neighbor Relations Table described in the second dynamic device mode change mechanism, to help make this determination.

In a fourth dynamic device mode change mechanism, the network may configure the device mode for a device. In this option, after the device registers to a first serving PLMN, the device's home PLMN may provide an indication to the device to operate in Single Access device mode, in Dual Connection device mode, or in Multi-UE device mode. The home PLMN may make this decision based on its own deployment, and/or based on the device's capability, and/or based on the device's subscription. An example method, may include at least one UE of the device is registered. Next the home PLMN of the registered UE uses one of the devices registrations to provide device mode information to the device. The device mode information may be provided to the device in a NAS message (e.g. registration accept or DL NAS message). Next, the device receives the NAS message (e.g. registration accept or DL NAS message) and forwards the device mode information to the CF. Lastly, the CF triggers a device mode change. For example, the device mode may be changed from Single Access device mode (one UE, using UICC1 and a 1st combination high-layer functionality/low-layer functionality/radio-transceiver functionality) to Multi-UE device mode. The CF activates the second UE (UE2). UE2 uses UICC2 and a 2nd combination of high-layer functionality/low-layer functionality/radio-transceiver functionality.

In a fifth dynamic device mode change mechanism, a device may change device mode based on application requirements. For example, some applications may have very stringent requirements for loss and would benefit from using multiple UEs to provide user plane enhancements. When starting such an application, the device may switch to a Multi-UE device mode. Similarly, when the device no longer has any ongoing applications that require multiple UEs to provide user plane enhancements, the device may switch back to Single Access device mode or Dual Connection device mode. The device may be configured with URSP rules, which indicate if the application requires user plane enhancements.

In cases that the device changes a device mode based on one (or combination) of the dynamic device mode change mechanisms previously described, the device may inform the network and/or RAN node about the change of device mode. For example, this may be via an RRC message or NAS message.

Example embodiments of Multi-UICC assistance information are now described. In the following, assistance information that may be provided to the device to help with device mode selection, PLMN search, and/or PLMN selection, are considered. This information is referred to as Multi-UICC assistance information.

In an example, a home PLMN may provide Multi-UICC assistance information to the device. The Multi-UICC assistance information may help the device: determine a device mode, determine when to perform PLMN search, and/or determine when to perform PLMN selection. This information may be received through a registration exchange procedure, a PDU session establishment/modification exchange procedure, or through a dedicated NAS signaling exchange. The information received by the device is provided to the CF.

The Multi-UICC assistance information may contain one or more of the following types of indication:
Indication of device mode to use for the device;
Indication that the device should stop PLMN search on one specific UE;
Indication that the device should start or continue PLMN search on one specific UE;
Indication that next generation deployment is sparse (e.g. next generation coverage is mostly hotspot);
Indication that next generation deployment is not available in a certain location. The location may be described as a cell, a group of cells, a tracking area, a group of tracking areas, a geolocation, a group of geolocations, a geofence, a group of geofences, a country, etc. ;
Indication that next generation deployment will be available at a certain location;
Indication that next generation deployment will be available at a certain time. For example, the operator may have scheduled to deploy the next generation network at a given location and/or at a certain date. This date may be provided to the device;
Indication that 5G deployment is sparse (e.g. 5G coverage is mostly hotspot);
Indication that 5G deployment is not available in a certain location;
Indication that 5G deployment will not be available at a certain time;
Indication that the device should enable Multi-UE device mode to provide interworking mobility (i.e. multiple UEs-used for interworking mobility);
Indication that the device should not enable Multi-UE device mode to provide interworking mobility; and/or
indication that the device should enable multi-UE device mode to provide user plane enhancements.

Embodiments for PLMN search and PLMN selection for Single Access device mode and Dual Connection device mode are disclosed. A method for PLMN search and PLMN selection for devices in Single Access device mode may include a first step where the CF retrieves the UICC stored PLMN lists from each UICC. Next, based on the retrieved lists, and the determined device mode, the CF determines, a PLMN search and PLMN selection strategy.

In an example PLMN search and PLMN selection strategy A, the CF has determined that the device mode is single access. The CF may also determine the PLMN/access technology/frequency band to use for the PLMN search and PLMN selection strategy A. In a first example method, the CF selects a UICC to use for the single access. For example, one UICC may be the default UICC or a primary UICC. In such a case, the device selects this UICC. Alternatively, the UICC may be prioritized and the CF selects the UICC with the highest priority. As another alternative, the CF may use the UICC that was last used by the device. As another alternative, the user may be prompted, for example through a graphical interface, to select a UICC to use for the Single Access.

The CF additionally selects the combination of high-layer functionality/low-layer functionality/radio transceiver functionality to use for the single access. The CF may make this determination based on the determined PLMN/access technology/frequency band. For example, the CF may determine to use 5G access technology. In such a case, the CF may select a combination of high-layer functionality/low-layer functionality/radio transceiver functionality that supports 5G. Alternatively, the CF may select the combination of high-layer functionality/low-layer functionality/radio transceiver functionality that is associated with the UICC. For example, each UICC may be associated with a combination of high-layer functionality/low-layer functionality/radio transceiver functionality or a preferred combination of high-layer functionality/low-layer functionality/radio transceiver functionality. The UICC and the selected combination of high-layer functionality/low-layer functionality/radio transceiver functionality is referred to as UE1

As an alternative to the first example method, the CF may select a combination of high-layer functionality/low-layer functionality/radio transceiver functionality first, and subsequently select the UICC that is associated with this combination.

In a next step, the device performs PLMN search and PLMN selection using UE1. The procedure may be based on the Release 18 procedure used in 5G networks. UE1 attempts to register with the selected PLMN. As part of the registration procedure, the home PLMN may provide Multi-UICC assistance information to the device.

Based on the Multi-UICC assistance information, the CF may determine that it needs to transition to Multi-UE device mode. The CF determines the PLMN/access technology/frequency band to perform the PLMN search for UE2. The CF provides this determined information to UE2.

When UE1 attempts to register with the selected PLMN, UE1 may fail to register to its prior Registered PLMN. To expedite PLMN selection, the device may perform an enhanced PLMN search and PLMN selection procedure. For example, the CF may enable an assistant UE (UE2) to perform its own PLMN search and PLMN selection, in parallel with UE1. The assistant UE using a second UICC and a second combination of high-layer functionality/low-layer functionality/radio transceiver functionality. The PLMN search and PLMN selection related to the assistant UE are controlled (starting and stopping) by the CF. For example, if the UE1 or assistant UE finds a PLMN to register on, the CF may stop the PLMN search and PLMN selection for the assistant UE. If the assistant UE finds the PLMN to register on, the CF may additionally provide the PLMN search results and/or PLMN selection results to UE1. This triggers UE1 to register on the found PLMN. As an alternative, if the assistant UE finds the PLMN to register on, the CF may decide to use the assistant UE (UE2) for operation in Single Access device mode, and to stop PLMN search and PLMN selection for UE1.

A method for PLMN Search and PLMN Selection for Dual Connection device mode may include a first step, where the CF retrieves the UICC stored PLMN lists from each UICC. In a next step, based on the retrieved lists, and the determined device mode, the CF determines, a PLMN search and PLMN selection strategy. In an example PLMN search and PLMN selection strategy B, the CF has determined that the device mode is dual connection.

In a first step of strategy B, the CF selects a UICC to use for the dual connection. For example, one UICC may be the default UICC or a primary UICC. In such a case, the device selects this UICC. Alternatively, the UICC may be prioritized and the CF selects the UICC with the highest priority. As another alternative, the CF may use the UICC that was last used by the device. As another alternative, the user may be prompted, for example through a graphical interface, to select a UICC to use for the dual connectivity.

The CF additionally selects the high-layer functionality/low-layer functionality/radio transceiver functionality to use for the dual connection. The CF may make this determination based on the master access for the dual connection. For example, the CF may determine that the deployment is only next generation+5G. In such a case, the CF may select a high-layer functionality/low-layer functionality/radio transceiver that supports next generation networks. The UICC and the selected combination of high-layer functionality/low-layer functionality/radio transceiver functionality is referred to as UE1

In a second step of strategy B, the device performs PLMN search and PLMN selection using UE1. The procedure may be based on the legacy procedure used in 5G networks. UE1 attempts to register with the selected PLMN. As part of the registration procedure, the home PLMN may provide Multi-UICC assistance information to the device. Based on the Multi-UICC assistance information, the CF may determine that it needs to transition to Multi-UE device mode. The CF determines the PLMN/access technology/frequency band to perform the PLMN search for the second UE (UE2). The CF provides this determined information to UE2.

When UE1 attempts to register with the selected PLMN, UE1 may fail to register to its prior Registered PLMN. To expedite PLMN selection, the device may perform an enhanced PLMN search and PLMN selection procedure. For example, the CF may enable an assistant UE (UE2) to perform its own PLMN search and PLMN selection, in parallel with UE1. The assistant UE using a second UICC and a second combination of high-layer functionality/low-layer functionality/radio transceiver functionality. The PLMN search and PLMN selection related to the assistant UE are controlled (starting and stopping) by the CF. For example, if the UE1 or assistant UE finds a PLMN to register on, the CF may stop the PLMN search and PLMN selection for the assistant UE. If the assistant UE finds the PLMN to register on, the CF may additionally provide the PLMN search results and/or PLMN selection results to UE1. This triggers UE1 to register on the found PLMN. As an alternative, if the assistant UE finds the PLMN to register on, the CF may decide to use the assistant UE (UE2) for operation in Dual Connection device mode, and to stop PLMN search and PLMN selection for UE1.

An example method for PLMN search and PLMN selection for Multi-UE device mode may include, when the device powers on or when the device returns to service, a first step where the CF retrieves the UICC stored PLMN lists from each UICC. Next, based on the retrieved lists, and the determined device mode, the CF determines, a PLMN search and PLMN selection strategy.

In an example PLMN search and PLMN selection strategy C, the CF has determined that the device mode is Multi-UE and then the device activates or enables a first UICC and a first combination of high-layer functionality/low-layer functionality/radio transceiver functionality, and a second UICC and a second combination of high-layer functionality/low-layer functionality/radio transceiver functionality. The device behaves like two UEs.

For PLMN selection, the device may have a number of PLMN lists stored on each UICC. For example, this may include lists such as “HPLMN Selector with Access Technology”, “User Controlled PLMN Selector with Access Technology” and “Operator Controlled PLMN Selector with Access Technology”. The operator may additionally provide a list for “Operator Controlled PLMN Selector with Access Technology”. As these lists may be independent, there may be cases that the lists will overlap and potentially conflict. For example, UICC1 and UICC2 may both have a list that prioritizes PLMN1 and RAT1, RAT2.

In addition to PLMN and access technology, the PLMN lists may be enhanced to include frequency band. This enhancement allows a UE to prioritize certain frequency bands over others while performing a PLMN search. This also allows the CF to deal with PLMN lists that may have overlapping entries and overlapping bands.

In an example method of strategy C, the CF may retrieve the UICC stored PLMN lists from each UICC as well as the prior Registered PLMN information for each UICC (if any). Next, based on the retrieved information, the CF determines, for each UICC, the PLMN/access technology/frequency band to perform the PLMN search (referred to as PLMN Search Information). In first alternative, the CF guarantees that the two UEs do not search the same PLMN/access technology/frequency band at the same time. In second alternative, where the two UEs are looking for the same PLMN, the CF may optimize the search logic so that one UE does the PLMN search and shares the results with the other UE via the CF. This will further optimize the radio scans for the multi-UE mode. In third alternative, the CF may obtain the PLMN lists and determine that 6G has priority over 5G. As a result, the CF may configure both UEs to search for 6G RAN nodes. In fourth alternative, the CF may obtain the PLMN lists and determine that 5G has priority over 6G. As a result, the CF may configure both UEs to search for 5G RAN nodes. In fifth alternative, the CF may determine that 5G and 6G have the same priority. As a result, the CF may configure UE1 to search for 5G RAN nodes and UE2 to search for 6G RAN nodes. In addition to the PLMN lists, the CF may determine a prioritized radio access technology (RAT). The CF uses this information to prioritize entries in the PLMN lists whose access technology matches the prioritized RAT(s). The prioritized RAT(s) may be pre-configured in the device, retrieved from the UICCs, or determined based on an indication carried in one of the PLMN lists.

The CF additionally selects a first combination of high-layer functionality/low-layer functionality/radio transceiver functionality for UICC1. The UICC1 and the first combination of high-layer functionality/low-layer functionality/radio transceiver functionality are referred to as UE1. The CF additionally selects a second combination of high-layer functionality/low-layer functionality/radio transceiver functionality for UICC2. The UICC2 and the second combination of high-layer functionality/low-layer functionality/radio transceiver functionality are referred to as UE2. The CF provides the PLMN Search Information to UE1 and UE2.

In a third step of strategy C, based on the provided PLMN Search Information, each UE (UE1 and UE2) performs a PLMN search for the determined access technology and frequency band. If a PLMN is found by UE1, UE1 may attempt to register to the found PLMN. In the following this will be referred to as Registration1. UE1 provides result of the PLMN search to the CF: successful registration OR unsuccessful registration OR PLMN not found. For unsuccessful registration, UE1 may additionally provide the cause of the failure (e.g. Tracking area not allowed).

In a fourth step of strategy C, if registration was unsuccessful or PLMN was not found, the CF determines the next PLMN/access technology/band combination, and repeats the third step for UE1. In a fifth step of strategy C, if registration was successful the device may receive Multi-UICC assistance information from the home PLMN. In a sixth step of strategy C, based on the Multi-UICC assistance information, the device may decide how to proceed with the PLMN search for UE2.

When UE1 is registered to a 5G network, the following options are possible for UE2 PLMN search. In a first option for UE2 PLMN search, the device may be preconfigured to always search for a PLMN on a 6G network. In a second option for UE2 PLMN search, the device may stop PLMN search for UE2. For example, the device may have Registration1 on a 5G network, and the device may receive deployment information that there is no next generation coverage in the current location. In such cases, there is no need to enable UE2 to look for a next generation network, and the CF may decide to disable UE2. The CF may additionally indicate to UE1 to enable dual connectivity if needed. UE1 may use this as an indication to notify the network of UE1, that dual connectivity may be activated. In a third option for UE2 PLMN search, the device may dynamically start and/or stop PLMN search for the UE2. The CF may determine to start/stop the UE2 PLMN search based on one or a combination of the following options (1)-(6):
(1) The determination to start/stop UE2 PLMN search may be based on device location. For example, the device may know, from the Multi-UICC assistance information, that 6G deployment exists in a certain geographical area (or doesn't exist in a certain geographical area). The device may check whether or not the device is located in a 6G deployment area. The CF may determine the device location based on the reports from the UE1. For example, the CF may indicate to UE1, that UE1 should report to the CF when the location of the device has changed. For example, the CF may request that UE1 report when the device:
   changes cell;
   changes tracking area;
   enters a certain cell or group of cells. The CF may provide the cell or group of cells in the request;
   enters a tracking area or group of tracking areas. The CF may provide the tracking area or group of tracking areas in the request;
   enters a geofence. The CF may provide the geofence in the request; and/or
   leaves a geofence. The CF may provide the geofence in the request;
(2) The determination to start/stop UE2 PLMN search may be based on time. For example, the device may know, from the Multi-UICC assistance information, that 6G deployment will occur after a certain date. The CF may start UE2 PLMN search after this date.
(3) The determination to start/stop UE2 PLMN search may be based on deployment information received from Registration1.
(4) The determination to start/stop UE2 PLMN search may be based Multi-UICC assistance information.
(5) The determination to start/stop UE2 PLMN search may be based on a service starting in the device, where the service requires Multi-UE device mode operation.
(6) The determination to start/stop UE2 PLMN search may be based an indication from the network received over UE1. For example, the Home PLMN may indicate that the device should start UE2 PLMN search. Alternatively, the Home PLMN may indicate that the device should stop UE2 PLMN search. The Home PLMN may additionally indicate how long to pause UE PLMN search. Alternatively, the Home PLMN may provide a timer value (or a schedule), indicating when to start and/or stop the PLMN search.

Based on the determination, the CF may provide the PLMN/access technology/frequency band to perform the UE2 PLMN search.

UE2 finds and selects a PLMN, and informs the CF. UE2 may perform a second registration. In the following, this is referred to as Registration2. Registration2 is for UE2.

The following options are possible for UE1 PLMN search. In a first option for UE1 PLMN search, UE1 PLMN search may follow the mechanisms described in TS 23.122V 18.8.0 , with the following additions. UE1 may have a separate set of operator controlled lists. A first set if the Multi-UE device mode is used for interworking mobility purposes, and a second set if the Multi-UE device mode is used for user plane enhancement purposes.

When UE2 is registered to a 6G network, the following options are possible for UE1 PLMN search. In a first option for UE1 PLMN search, the device may be preconfigured to always search for a PLMN on a 5G network.

In a second option for UE1 PLMN search, the device may stop PLMN search for UE1. For example, the device may have Registration1 on a 6G network, and the device may receive deployment information that there is no 5G coverage in the current location. In such cases, there is no need to enable UE1 to look for a 5G network, and the CF may decide to disable the UE1. The CF may additionally indicate to UE2 to enable dual connectivity if needed. UE2 may use this as an indication to notify the network of UE2 that dual connectivity may be activated.

In a third option for UE1 PLMN search, the device may decide to continue UE1 PLMN. For example, the device may have Registration1 on a next generation network, and the device may receive deployment information that the next generation coverage is limited. In such cases, the device may need the second registration to a 5G network, to enable switching to the 5G network when next generation coverage is lacking. In this case, the device should not stop UE1 PLMN search. Instead UE1 should continue to look for a 5G network.

In a fourth option for UE1 PLMN search, the device may dynamically start and/or stop PLMN search for the UE1. The CF may determine to start/stop UE1 PLMN search based on one or more of the following options (1)-(5).
(1) The determination may be based on device location. In one example, the CF may determine the device location based on the reports from the UE2. For example. the CF may indicate to UE2, that UE2 should report to the CF when the location of the device has changed. For example, the CF may request that UE2 report when the device:
   changes cell;
   changes tracking area;
   enters a certain cell or group of cells. The CF may provide the cell or group of cells in the request;
   enters a tracking area or group of tracking areas. The CF may provide the tracking area or group of tracking areas in the request;
   enters a geofence. The CF may provide the geofence in the request; and/or
   leaves a geofence. The CF may provide the geofence in the request.
(2) The determination may be based on time. For example, the device may know from the Multi-UICC assistance information that 5G network in a certain area will be decommissioned at a certain time. The CF may stop UE1 PLMN search after this date.
(3) The determination may be based on deployment information received from Registration1.
(4) The determination may be based Multi-UICC assistance information.
(5) The determination may be based an indication from the network received over UE2. For example, the Home PLMN may indicate that the device should start UE1 PLMN search. Alternatively, the Home PLMN may indicate that the device should stop UE1 PLMN search. The Home PLMN may additionally indicate how long to pause UE PLMN search. Alternatively, the Home PLMN may provide a timer value (or a schedule), indicating when to start and/or stop the PLMN search. Based on the determination, the CF may provide the PLMN/access technology/frequency band to perform the UE1 PLMN search.

Once UE1 finds and selects a PLMN and informs the CF, UE1 performs a second registration. In the following, this is referred to as Registration2. Registration2 is for UE1.

The UE 2 PLMN search may follow mechanisms described in TS 23.122V 18.8.0 , with the following additions. UE2 may have a separate set of operator controlled lists. A first set if the Multi-UE device mode is used for interworking mobility purposes, and a second set if the Multi-UE device mode is used for user plane enhancement purposes.

Example embodiments for registration management for devices in Multi-UE device mode are now described.

In the case that the device has selected Single Access device mode or Dual Connection device mode, the single UE registers with the selected PLMN. As part of the registration procedure, the home PLMN may provide Multi-UICC assistance information to the device.

In the case that the device has selected Multi-UE device mode, each UE may register with a mobile network. The device performs PLMN search and PLMN selection strategy C. As part of this strategy, a first UE (UE1) registers with a PLMN—this is registration1 to PLMN1.

For the registration of UE2, the following options are possible. Registration of UE2 option 1: after UE2 finds and selects a PLMN, this is a trigger for UE2 to register with the selected PLMN.

Registration of UE2 option 2: after UE2 finds and selects a PLMN, UE2 determines if the registration is needed, based on factors such as deployment information, time, active service data flows, etc. For example, the device may determine that it has active service data flows that require Multi-UE functionality that provides user plane enhancement, and UE2 may choose to register with the selected PLMN. For example, the device starts an application. The device evaluates if user plane enhancement is needed and uses this as a trigger to perform a registration of UE2. The device may be configured to behave differently depending on why Multi-UE device mode is needed. For example, one behavior may be desired if Multi-UE device mode is needed for user plane enhancements and a different behavior may be desired if Multi-UE device mode is needed for interworking mobility.

Registration of UE2 option 3: UE2 registers with the home PLMN, prior to finding and selecting a PLMN. This may be used in cases that the Multi-UE device mode is used for interworking mobility and Registration1 is to a 5G network. In such a case, UE2 may register to the home PLMN over the NAS connection of UE1. The steps are described below.

In a first step, a device has determined to use Multi-UE device mode for interworking mobility. The device is in 5G coverage and UE1 is registered to 5G network. UE1 has connectivity over the 5G network. Device (e.g. CF) determines to register UE2 to the home network (which is a 6G network) to allow for interworking mobility. The device has no 6G coverage.

In a second step, the CF retrieves the registration request message from UE2. The CF may additionally retrieve an indication of the device's home PLMN.

In a third step, the CF may create a NAS message that includes the registration request for UE2 as well as the home PLMN. The registration request may indicate that the registration is for interworking mobility purposes. The NAS message is sent to PLMN1 (AM_NF), for example in an UL NAS Transport message.

In a fourth step, the AM_NF of PLMN1 forwards the registration request for UE2, to the home PLMN. This may be sent to the network function responsible for registration management in the home PLMN

In a fifth step, the home PLMN either accepts or rejects the registration request. The home PLMN prepares a Registration Response and provides the response to the AM_NF of PLMN1.

In a sixth step, the AM_NF of PLMN1 forwards the registration response to the device (to UE1). For example, this may be using a DL NAS Transport message.

In a seventh step, UE1 forwards the NAS message to the CF. The CF extracts the Registration Response message and forwards the message to UE2.

At step eight, UE2 is now registered with the home PLMN (Registration2). Using Registration2, UE2 may be configured to periodically perform registration update procedures over the NAS connection of UE1. Alternatively, UE2 may be configured to not perform periodic registration updates for Registration2.

In a ninth step, UE2 may continue with PLMN search and PLMN selection strategy C. When UE2 determines that it has connectivity to the home PLMN, it may send a NAS message to the home PLMN. The network uses the message to conclude that the device is reachable via an access over UE2. For example, this may be a Registration Update message.

For Registration of UE2 options 1-3, the device may lose connectivity to PLMN2. When this happens, Registration2 may be maintained. A first way to maintain Registration2 is by configuring UE2 to not send periodic registration updates. In a second way to maintain Registration2, UE2 may send periodic registration updates to PLMN2 via UE1.

The UEs may inform the CF when they have ‘registered to’/‘deregistered from’ a PLMN. The UE may also provide the PLMN ID to the CF. The operation over the two registrations may be different. For example, the two registrations may have different periodic registration timers, different deactivation timers, etc. Alternatively, if one of the registrations is for a next generation network, the registration may be configured to not use a deactivation timer.

In a case when a UE registration (UE1 or UE2) when all service data flows (SDFs) are switched to the other UE, certain considerations are required. For example, in the case that the device has selected Multi-UE device mode, all SDFs may be switched from one UE (e.g. UE1) to the other UE (e.g. UE2). In such cases, the device may always decide to deregister UE1, or it may determine to deregister UE1 based on one or more conditions. For example, if the device mode is used for interworking mobility, the device may decide to keep both registrations. This may be useful in cases that SDFs are switched back due to hotspot coverage. As another example, if the device mode is used for interworking mobility and the device knows that there is no deployment in a certain area that may use UE1 registration, then the device may decide to deregister UE1. If the device determines to deregister UE1, the Deregistration request may be sent using UE1. Alternatively, the CF may be used to send the Deregistration request inside a NAS container using UE2.

Embodiments for PDU session management will now be described. In the following, procedures for session management for devices in Multi-UE device mode, are considered.

In the case that the device has selected Single Access device mode or Dual Connection device mode, the selected UE establishes a PDU session with the selected PLMN. In the case that the device has selected Multi-UE device mode, each UE may establish a PDU session.

In a first session management option, the two PDU sessions may be unlinked. This may be useful for cases that the device uses the two UEs to provide Multi-SIM capability. In this option, each UE is registered to a PLMN, referred to as the registered PLMN of the UE. In this option, each UE independently manages its own PDU sessions with the registered PLMN of the UE.

In a second session management option, the two PDU sessions may be linked. This may be useful for cases that the device uses the two UEs to provide interworking mobility during 5G to 6G migration, or to provide user plane enhancement to applications running on the device. The user plane enhancement may be in terms of throughput, reliability, latency/delay, etc. In this second session management option, the CF may control when each UE establishes a PDU session. The CF may be aware if a UE has registered with a PLMN.

Examples for how the control function (CF) controls PDU session management for each UE may include the following options. In a first control option, the device may determine to behave in Multi-UE device mode, and the device may be configured to use the Multi-UE device mode for user plane enhancement. This is similar to ATSSS (TS 23.501) and DualSteer (TR 23.700-54) in 5G networks. The CF may know that UE1 is registered to PLMN 1 and that UE2 is registered to PLMN2. In some cases, UE1 and UE2 may be registered to the same PLMN (i.e. PLMN1==PLMN2). The CF may request that UE1 establish a PDU session over PLMN1 and that UE2 establish a PDU session over PLMN2. For example, this may be useful in cases that a device has started an application data flow that requires improved performance (e.g. in terms of throughput, reliability, delay).

In a second control option, the device may determine to behave in Multi-UE device mode, and the device may be configured to use the Multi-UE device mode for interworking mobility. The CF may know that UE1 is registered to PLMN1 and that UE2 is registered to PLMN2. In some cases, UE1 and UE2 may be registered to the same PLMN (i.e. PLMN1==PLMN2). One of the registrations is to a 5G network, while the other registration is to a next generation network. In the following it will be assumed that UE1 is registered to a 5G network and UE2 is registered to a 6G network. When the device starts an application that requires a new PDU session, the CF requests UE1 to establish a PDU session. If the Multi-UE device mode is configured to handle hotspot 6G RAN nodes, the CF will rely on the 5G network for the main PDU session. Similarly, if the Multi-UE device mode is configured handle hotspot 5G RAN nodes, the CF will rely on the 5G network for the main PDU session.

In the following description, handling of various PDU session types are discussed. A device uses a PDU session to transfer user plane traffic from the device to a user plane session anchor. A device configured for Multi-UE device mode, may have a PDU session that may be of different types as follows:
(1) Single Access PDU session: a session with a single user plane path between a UE and the user plane session anchor;
(2) Multi-Access PDU session: a session with two user plane paths between a UE and a user plane session anchor. The device maintains a separate registration for each of the 2 user plane paths of a Multi-Access PDU session; and
(3) Multi-UE PDU session: a session with two linked single access PDU sessions. The two PDU sessions may have user plane paths to the same user plane session anchor. This user plane anchor may be in a visited PLMN or in the Home PLMN. Alternatively, the two PDU sessions may have user plane paths to different user plane session anchors. For example, one PDU session with a user plane path that uses local breakout, to a user plane session anchor in a visited PLMN, and a second PDU session with a user plane path that uses home routing, to a user plane session anchor in a home PLMN. A Multi-UE PDU session may be used for user plane enhancements (for example improved throughput, lower delay, lower loss) or for interworking mobility scenarios (e.g. between 5G and 6G networks)

In the following, discussion is presented to consider how a device decides what kind of PDU session to start. The device/WTRU is provided with a route selection policy to determine how to route traffic for this application. For example, this route selection policy may be a user equipment route selection policy (URSP) rule as described in TS 23.501. The route selection policy may be enhanced to include PDU Session Information including one or a combination of information in items (1)-(5) below:
(1) Information on how to start PDU session: For example, start a Multi-UE session, start a Single Access PDU session, start a Multi Access PDU session. This information may be indicated in the RSD part of the URSP Rule.
(2) Service Continuity Information: indication that service requires service continuity. This may include a level of service continuity, for example: none, upon change of session anchor, upon change of PLMN, upon migration to/from one generation to another, upon change of IP address, etc. Session and Service Continuity (SSC) Mode, described in TS 23.502, is a subset of the Service Continuity Information. SSC modes relate mostly to service continuity related to changes in session anchor. Service Continuity Information additionally applies to service continuity related to change in PLMN, migration from one generation to another.
(3) Preferred Connectivity: For example, an indication whether the service prefers: 5G connectivity (e.g. user plane path through 5G RAN node and 5GC core network), 6G connectivity (e.g. user plane path through 6G RAN node and next generation core network), or either. A service that prefers 6G connectivity is a service that needs to take advantage of features that are supported in 6G systems and that are not supported in 5G systems. The preferred connectivity may also be in terms of: preferred PLMNs, preferred network generation, preference of NPN vs PLMN, preference on home PLMN vs visited PLMN, preferred RAT, preferred RAT type (e.g. terrestrial, satellite, non-3GPP), etc.
(4) Multi-UE Session ID: an identifier shared between the PDU sessions of a Multi-UE PDU session
(5) Always_On indication: Indication that PDU session should not timeout due to inactivity

The route selection policy may be pre-configured in the device, for example in the common device layer. Alternatively, or in addition, the route selection policy may be provided to the device using NAS signaling from the home PLMN.

A PDU session can host all service flows that select the same route based on the route selection policy.

Examples of how a device determines which UE to use to send a PDU Session Establishment request are now discussed. When an application starts, the device determines to establish a new PDU session or use an existing PDU session. If device determines to establish a new PDU session, the device sends a PDU session request to a SM_NF, which is responsible for session management. The CF determines how to send the request based on device mode and PDU Session Information.

If device mode is Single Access or Dual Connection, the CF will select the single UE, which will transmit the PDU session request.

If the device mode is Multi-UE, the PDU Session Type is Multi-Access PDU session or Multi-UE PDU session, and the device is registered for UE1 and not registered for UE2, the CF will select UE1 to transmit the request. In addition, the device may use the PDU session establishment request as a trigger to start PLMN search and selection for UE2.

If the device mode is Multi-UE, the PDU Session Type is Multi-Access PDU session or Multi-UE PDU session, and the device is registered for UE2 and not registered for UE1, the CF will select UE2 to transmit the request. In addition, the device may use the PDU session establishment request as a trigger to start PLMN search and selection for UE1.

If the device mode is Multi-UE, the PDU Session Type is Multi-Access PDU session or Multi-UE PDU session, and the device is registered for UE1 and registered for UE2, the CF will transmit the PDU session establishment request using both UE1 and UE2.

If the device mode is Multi-UE, the PDU Session Type is Single-Access PDU session, and the device is registered for UE1 and registered for UE2, the CF may use PDU Session Information to help select the UE. If the PDU session requires service continuity the CF may select the UE that is registered to the next generation core network. If the PDU session has a preferred core network, the CF may select the UE that is registered to the preferred core network.

When an application has selected a Multi-Access PDU session or Multi-UE PDU session, and the device has a single user plane path set up for the PDU session, then upon registering for the second user plane path, the device sends a PDU Session request and establishes the second user plane path.

Example optimizations to establish and maintain a second PDU session for a Multi-UE PDU Session are disclosed. For a Multi-UE PDU Session, the device has two PDU sessions. PDU session1 for UE1 and PDU session2 for UE2. Each of these PDU sessions may have activated or deactivated user plane connections.

In one option, a device may establish both PDU sessions, by sending a single PDU session establishment request. The device sends a first PDU session establishment request to a first SM_NF. The request may include a second PDU session establishment request within a container. The second PDU session establishment request may include an indication if UE2 is reachable, and if UE2 is reachable, the second PDU session establishment request may include an identifier of the RAN node over which UE2 may be reached. The first SM_NF forwards the second PDU session establishment request to a second SM_NF, which handles establishment for the second PDU session. The first SM_NF will establish the first PDU session and return a first PDU session establishment response which includes the second PDU session establishment response within a container. If UE2 is not reachable, the second PDU session may be set up with its user plane connection deactivated. If UE2 is reachable, the second PDU session may be set up with its user plane connection activated

Example contents of the PDU session establishment request are disclosed. The PDU session establishment request, may contain one or more of the following:
PDU Session ID: an identifier for the PDU session. This identifier may be used to link the two PDU session establishment requests that belong to a single Multi-Access PDU session. The identifier may be used to link the two PDU sessions that belong to a Multi-UE PDU session;
Multi-UE Session ID;
preferred connectivity;
Service Continuity indication: this may be used as an indication to the network, to start a Multi-UE PDU session for interworking mobility;
Stickiness indication: indication to network that the PDU session should have some stickiness to its Preferred Connectivity. For example, when a device is in coverage of both 5G and 6G and the PDU session has a preferred connectivity of 5G, then the network should leave PDU session on 5G, even in mobility scenarios
Always_On indication;
SM_Container: A container that carries the PDU session establishment request from other UEs of the device;
PDU Session Type: Indication of the type of Multi-UE PDU session. This may indicate a Multi-UE PDU session that is targeting interworking mobility, or a Multi-UE PDU session that is targeting user plane enhancement. For example, PLMN1 may use the indication to determine that the PDU session needs to be home routed; and/or
Home-Routed indication: This is used by the network to start a Multi-UE PDU session that is home routed to the home PLMN or that uses local breakout in the visited PLMN.

Example embodiments of Multi-UE rules are now described. In the following, rules for steering, switching, splitting, and duplication are considered. These are referred to as Multi-UE rules.

The SM_NF, provides the Multi-UE rules to the device, in particular to the CF. The rules allow the CF to determine how to steer uplink traffic from a service data flow over one user plane path, how to switch uplink traffic from a service data flow from one user plane path to another user plane path, how to split uplink traffic from a service data flow over two user plane paths, and/or duplicate uplink traffic from a service data flow over two user plane paths. In addition, the SM_NF, provides the Multi-UE rules to the user plane anchor, to steer, switch, split, or duplicate downlink traffic of a service data flow.

A device may be provided a prioritized list of Multi-UE rules for uplink traffic. A user plane anchor may be provided a prioritized list of Multi-UE rules for downlink traffic. Each Multi-UE rule may have an identifier to identify one or more service data flows to which the rule applies. The Multi-UE rule may additionally have the steering, switching, splitting, duplication (SSSD) mode to use to help direct traffic to the one or both user plane paths.

In the following, considerations of the steering, switching, splitting, and duplication (SSSD) modes are discussed. It is assumed that a first user plane path is over a 5G network, while a second user plane path is over a next generation network. The following SSSD modes may be used in isolation or in combination.

SSSD Mode 1: Based on availability of a user plane path. One user plane path may be considered as a default main user plane path. If available, all traffic of the matching service data flow should be transmitted over this path. If this path is not available, the traffic of the matching service data flow should be transmitted over the other user plane path

SSSD Mode 2: Based on “signal quality” of each user plane path. Steer or switch traffic to the user plane path with the better signal quality. The signal quality may be based on measurements made by UE1 and/or UE2. These measurements include received signal strength (such as reference signal received power (RSRP), reference signal received quality (RSRQ), signal interference to noise ratio (SINR)). For example, if the signal strength of the 6G RAN node is better than the signal strength of the 5G RAN node, the CF may decide to switch traffic matching the service data flow filter to the 6G RAN node. As another example, if the signal quality of the 6G RAN node is above a threshold, the CF may decide to switch traffic matching the service data flow to the 6G RAN node. As another example, if the signal quality of the 6G RAN node falls below a threshold, the CF may decide duplicate traffic matching the service data flow filter over both the 5G RAN and 6G RAN.

SSSD Mode 3: Based on “Access stratum metrics” of each user plane path. Steer or switch traffic to the user plane path with the better Access stratum metrics. The Access stratum metrics may be based on some statistical measure related to hybrid automatic repeat request (HARQ), radio link control (RLC), and/or packet data convergence protocol (PDCP).

SSSD Mode 4: Based on “connectivity quality” of each user plane path. Steer or switch traffic to the user plane path with the better connectivity quality. The connectivity quality may be based on measurements made by UE1 and/or UE2. These measurements include Packet loss rate and/or Average delay below a threshold

SSSD Mode 5: Based on load of each user plane path. Steer or switch traffic to the user plane path with the lower load or that is less congested. The RAN nodes of each user plane path may broadcast an indication of load conditions. The CF may decide to switch traffic matching the service data flow filter to the user plane path that is less congested. Load or congestion may be based on load in the control plane, load on the user plane, number of UEs in CONNECTED mode, number of UEs in IDLE mode, number of UEs in INACTIVE mode, etc.

SSSD Mode 6: Based on command or request from a RAN node. For example, a device may have uplink traffic over a 5G RAN node. The 5G RAN node may decide to handover (effectively switch or transfer) the device's traffic to a 6G RAN node. The 5G RAN node may send a Handover Command to the device, which is forwarded to the CF. The CF switches the uplink traffic over to the 6G RAN.

SSSD Mode 7: Based on command or request from a network node. For example, a device may have uplink traffic over a 5G RAN node. The network may decide to handover (effectively switch or transfer) the device's traffic to a 6G RAN node. The network node may send a Transfer Command to the device, which is forwarded to the CF. The CF switches the uplink traffic over to the 6G RAN.

SSSD Mode 8: Based on a preferred connectivity. For example, a service data flow may prefer: 5G connectivity (e.g. user plane path through 5G RAN node and 5GC core network), 6G connectivity (e.g. user plane path through 6G RAN node and next generation core network), or either. A service data flow that prefers 6G connectivity is a service data flow that needs to take advantage of features that are supported in 6G systems but that are not supported in 5G systems or that are supported more efficiently in the 6G system. A service data flow that prefers 5G connectivity is a service data flow that needs to take advantage of features that are supported in 5G systems but that are not supported in 6G systems or that are supported more efficiently in the 5G system. If both 5G connectivity and 6G connectivity are available, the CF switches the uplink traffic over to the preferred connectivity.

As described above, the Multi-UE rules are applicable at the granularity of a service data flow. As an alternative, some Multi-UE rules may be applicable at the granularity of a PDU session. In such a case, the modes apply to matching PDU sessions. As another alternative, some Multi-UE rules may be applicable at the granularity of a UE. In sch conditions, the modes apply to all traffic of a UE.

Examples for how a device determines the Multi-UE rules are disclosed. A device may obtain or determine the Multi-UE rules via one or more of the following mechanism:
Some Multi-UE rules may be pre-configured in the device. For example, the Multi-UE rules related to mobility between 5G and 6G networks may be pre-provisioned in the CF. These rules are expected to be rather static
Some Multi-UE rules may be received during registration. For example, when a UE of the device registers with a network, the network may provide Multi-UE rules in the Registration accept message.

Some Multi-UE rules may be received during session establishment. For example, when a UE of the device sends a PDU Session establishment request, the network may provide Multi-UE rules in the PDU session establishment accept message.

Some Multi-UE rules may be received with dedicated NAS signaling between the network and the device.

Example of Multi-UE measurement configuration are disclosed. In the following, procedures for configuring device measurements to assist in evaluating the Multi-UE rules, are considered.

The measurement configuration is used by the device (e.g. the CF in the device) to determine measurements that help evaluate the Multi-UE rules. The measurement configuration may be used to find 5G and 6G RAN nodes to assist in interworking mobility.

The measurement configuration may be pre-configured, provisioned via NAS signaling, and/or provisioned via RRC signaling. For example, UE1 may be registered over a 5G network. The 5G RAN node may send the measurement configuration to the device for inter-RAT (i.e. 6G) measurements. The CF may use the measurement configuration to configure the individual UEs with:
What to measure (e.g. received signal strength, such as RSRP);
When to measure (e.g. every K1 msec);
How often to report the measurement to the CF. This may be periodic or event based (e.g. report every K2 msec, or report when measured quantity changes by K3%); and/or
If the measurement report should be sent to the RAN node, should be reported back to the CF, or both

The measurement configuration for the individual UEs may be based on location and known deployment. For example, a 5G RAN node may only send the measurement configuration for 6G measurements, if the 5G RAN node knows that the device is in a location with 6G RAN deployments. Alternatively, the device (e.g. CF) may autonomously determine to stop measurements if it is aware that the device is in a location where no deployment exists for the configured measurements.

In the case that the device uses the UE measurements to make steering, switching, splitting, and duplication decisions, the CF may use thresholds and hysteresis to make these decisions. As an alternative to receiving the measurement reports from the individual UEs, the CF may retrieve the measurement reports from the UEs.

Example embodiments for Interworking Mobility are disclosed. A device may need to determine how to enable service continuity during interworking mobility scenarios. This determination may be based on the device mode.

A device may determine that it may not use Multi-UE device mode for interworking mobility. This occurs when the device is in Single Access device mode, or when the device is in Dual Connection device mode, or when the device is in Multi-UE device mode but the multiple UEs are used for user plane enhancements. In such conditions, the device relies on the use of Dual Registration to provide service continuity during the mobility scenarios. A UE of the device will register over both the 5G network and the 6G network. When service continuity is needed during a mobility event, the device may perform a PDU session handover from the 5G network to the 6G network (or from the 6G network to the 5G network).

A device may determine that it may use Multi-UE device mode for interworking mobility. In such a cases, service continuity during Interworking Mobility scenarios is described below. Namely, how a device behaves when one or more service data flows are switched from one UE to another (UE1 to UE2 or UE2 to UE1).

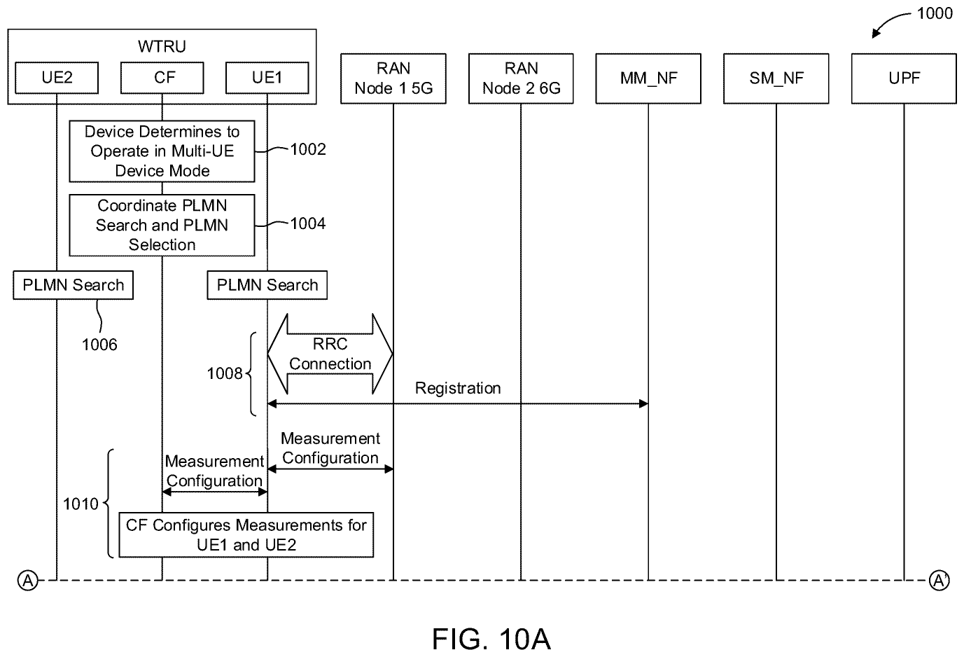

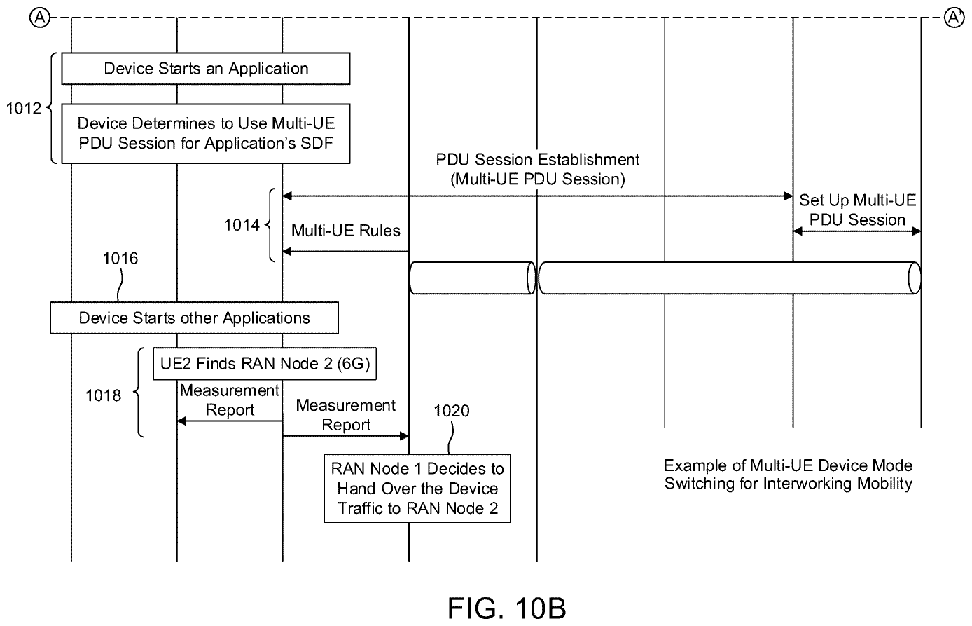

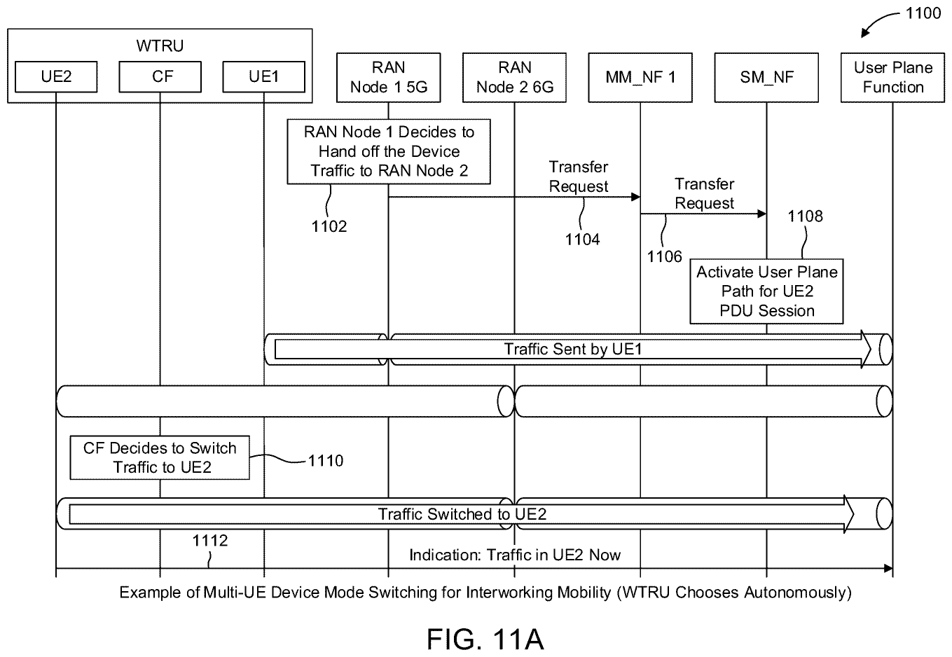

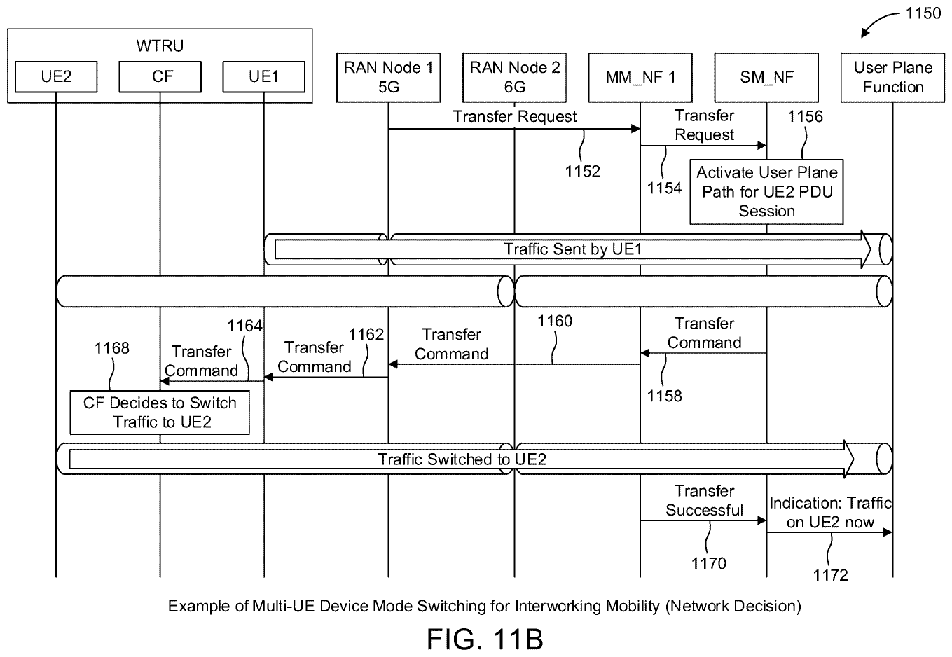

When the device determines to operate in Multi-UE device mode to enable Interworking Mobility, one UE is connected to the 5G RAN node and 5G core network (e.g., UE1) and the other UE is used to connect to the 6G RAN node and 6G core network (e.g., UE2). Example embodiments are described below in reference to FIG. 10 and FIGS. 11A and 11B.

Referring to FIG. 10A and continuing on FIG. 10B, an example method 1000 is shown for Multi-UE device switching for Interworking Mobility. Entities shown in FIGS. 10A and 10B method 1000 may include a WTRU having UE1, UE2 and a control function (CF), RAN Node1 (5G), RAN Node2 (6G), a mobility management network function (MM_NF), a session management network function (SM_NF) and a user plane function (UPF). At step 1002, based on device mode selection (described previously), the WTRU decides to use Multi-UE device mode. The WTRU may also determine if the subscriptions for UE1 and UE2 are linked or unlinked (as previously described). At step 1004, the CF coordinates PLMN search and PLMN selection for UE1 and UE2. At step 1006, UE1 and UE2 perform PLMN search and PLMN selection as described previously.

At step 1008, UE1 finds RAN node 1 and registers with core network 1, e.g., via the MM_NF. In the following, it is assumed that RAN node 1 and core network 1 are part of a 5G system. As an option, UE1 may also carry the registration message for UE2. At step 1010, UE1 receives a measurement configuration from RAN node 1. The configuration may include inter-RAT monitoring events related to the 6G system, as described previously. UE1 may forward the measurement configuration to the CF, which configures the measurements for the individual UEs. At step 1012, the WTRU starts an application. The WTRU determines to use a Multi-UE PDU session for the application's service data flows (SDF).

At step 1014, UE1 sends a PDU session establishment request to SM_NF1. The request is for a Multi-UE PDU session. A first user plane (UP) path is established using UE1, RAN node 1 and user plane anchor (UPF). The UE1 PDU session is activated (the Multi-UE PDU session is shown as a tunnel/tubular shape in FIG. 10). The Multi-UE PDU session include (or activates pre-configured) Multi-UE rules for steering, switching, splitting, duplicating the SDFs. The Multi-UE rules are provided to/used by the CF. As an option UE1 could additionally provide PDU session establishment request for UE2. The user plane path for UE2 PDU session is deactivated.

At step 1016, the WTRU/device starts other applications. The device determines to transport the SDFs of these applications over new PDU sessions, over new Multi-UE PDU sessions, or over the existing Multi-UE PDU session. At step 1018, the WTRU finds an inter-RAT cell based on the measurement configuration and a measurement report is provided by UE1 to RAN node 1. Additionally, the measurement report may be provided to the CF. At step 1020, based on the received measurement report, RAN node 1 may decide to transfer one, multiple, or all PDU sessions of the WTRU/device to RAN node 2.

Referring to FIG. 11A, in a first option A shown in method 1100, the previous method may continue where the WTRU/device decides autonomously to switch traffic from UE1 to UE2, e.g., based on measurements & Multi-UE rules. Method 1100 may include the following steps. At step 1102, RAN node 1 decides to handoff the device traffic to RAN node 2 (as in step 1020 from FIG. 10) and at step 1105, notifies the MM_NF1 of the transfer request. At step 1106, the MM_NF1 sends a request to the SM_NF requesting to transfer the PDU sessions to RAN node 2. At step 1108, the SM_NF activates the user plane path for the UE2 PDU session. For example, the network may use a network triggered Service Request procedure.

At step 1110, the CF uses the measurement reports and the Multi-UE rules and determines to switch the traffic from UE1 to UE2. The UE2 then begins to send uplink traffic from the flow over UE2. At step 1112, the WTRU/device, e.g., using UE2, sends a message to the UPF, to indicate to the UPF, that the device has changed connectivity for one or more specific service data flows, QoS flows, or PDU sessions. The UPF uses this as an indication to also switch downlink traffic for UE2 of the device/WTRU. Alternatively, the UPF may rely on reception of unlink traffic to trigger the switching for the downlink traffic. The UPF then begins to send downlink traffic from the flows over UE2.

Referring to FIG. 11B, in a second option B shown in method 1150, the FIG. 10 method 1000, may continue where the network tells the WTRU/device to switch traffic from UE1 to UE2. Method 1150 may include the following steps. At step 1152, RAN Node 1 notifies the MM_NF1 of the transfer request and at step 1154, the MM_NF1 sends a request to SM_NF requesting to transfer the PDU sessions to RAN node2. At step 1156, the SM_NF activates the user plane path for the UE2 PDU session. At step 1158, the SM_NF sends Transfer command to MM_NF1 and at step 1160, the MM_NF1 sends a Transfer command to RAN node 1. In one example, this may be a HANDOVER Request message.

At step 1162, RAN node 1 sends a Transfer command to UE1. In one example, this may be sent as an RRC reconfiguration. The Transfer command in steps 1158, 1160 and 1162 may include an indication to transfer all PDU sessions, specific PDU sessions, or only those whose Multi-UE rules indicate a SSSD mode based on Transfer command or Handover Command. At step 1164, UE1 forwards the Transfer command to the CF and the CF switches SDFs, QoS flows, or PDU sessions to UE2 at step 1168. The WTRU/device then begins to send uplink traffic from the flow over UE2.

At step 1170, the MM_NF1 may notify SM_NF that the transfer was successful and at step 1172, the SM_NF may notify the UPF that device has changed connectivity for a specific service data flow, QoS flow, or PDU session. The UPF uses this as an indication to also switch downlink traffic for the device. Alternatively, the UPF may rely on reception of unlink traffic to trigger the switching for the downlink traffic. The UPF then begins to send downlink traffic from the flows over UE2 (not shown).

In a third Option C a combination of Option A and Option B may be used. The device is provided a Transfer command, which triggers the CF to switch, split, steer, duplicate according to the Multi-UE rules. For options A, B, and C if the Multi-UE rules cause all the SDFs to be switched to the UE2 PDU session, the device may decide to deactivate user plane resources on the UE1 PDU session. For example, UE1 may send a NAS message to SM_NF to indicate a UE-initiated selective deactivation of UP connection of an existing PDU Session. The message may include an ID of the PDU session that is being deactivated, as well as a cause for the deactivation. Potential causes include:
All SDFs on PDU session inactive for a period of time;
All SDFs on PDU session transferred to another PDU session.

This indication may be included in a PDU Session Modification request. In response, the SM_NF may determine whether to accept the request to deactivate the user plane connection of the PDU session. If yes, the SM_NF may release the core network tunnels associated with the PDU session, and the NG-RAN resources associated with the PDU session.

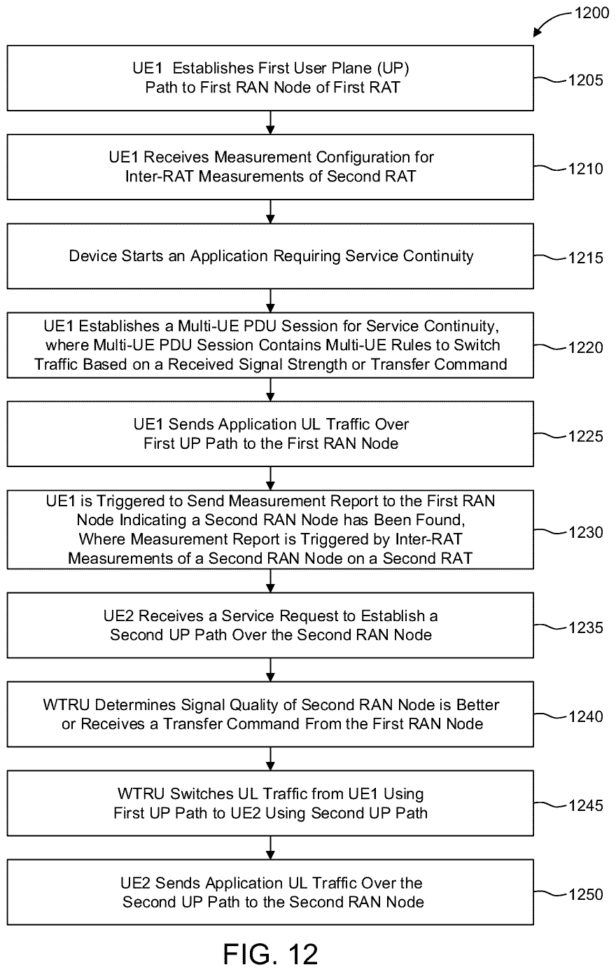

Referring to FIG. 12, an example method 1200 is shown for a wireless transmit receive unit (WTRU) having a first universal integrated circuit card (UICC) and a second UICC using multiple UEs for Interworking, according to an example embodiment. In method 1200, it is assumed the WTRU retrieves subscription profile IDs from the first UICC and the second UICC and based on the retrieved subscription profile IDs, the WTRU determines it may support a multi-UE mode of operation using a first UE (UE1) and a second UE (UE2) of the WTRU to operate for mobility between inter-radio access technologies (RAT) networks. It is assumed that UE1 is registered over a first radio access technology (RAT) and UE2 is registered over a second RAT.

At step, 1205, UE1 establishes a first user plane (UP) path to a first RAN node of a first RAT (e.g., RAN node 1 for 5G). UE1 receives 1210 measurement configuration for inter-RAT measurements of a second RAT (e.g., RAN node 2 for 6G). The device/WTRU starts 1215 an application requiring service continuity and UE1 establishes a Multi-UE PDU session for service continuity where the Multi-UE PDU session contains or activates Multi-UE rules to switch traffic based on occurrence of a triggering event, e.g., a received signal strength of RAN node 2 (6G) being greater than RAN node 1 (5G) or a Transfer command received from RAN node 1, as discussed in previous embodiments.

UE1 sends 1225 uplink (UL) application traffic over the first UP path to the first RAN node, i.e., via an established PDU session with the first RAN node. At step 1230, UE1 is triggered to send a measurement report to the first RAN node (RAN node 1) indicating a second RAN node (RAN node 2) has been found. The measurement report may be triggered by inter-RAT measurements of the second RAN node on the second RAT (e.g., 6G). In one example, UE2 receives 1235 a paging message or Service Request to establish a second user plane (UP) path with the second RAN node. In response to a triggering event of the Multi-UE rules to switch traffic occurring, i.e., measurements or receipt of the Transfer command, the WTRU switches 1245 UL application traffic from UE1 using the first UP path, to UE2 using the second UP path with the second RAN node. As with any of the embodiments disclosed herein, steps of method 1200 may be performed in any order, omitted or modified with steps of any other method disclosed herein where suitably feasible.

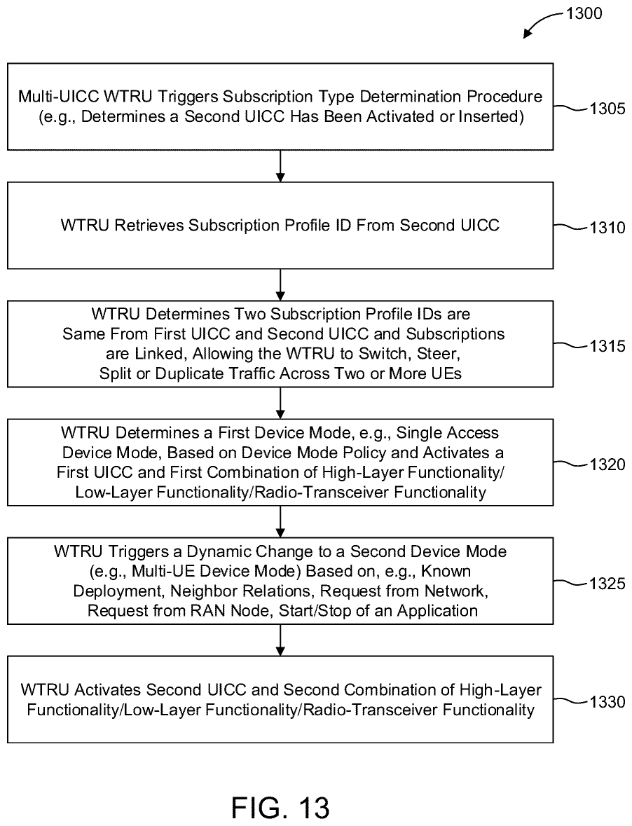

Referring to FIG. 13, a method 1300 for device/WTRU determination of subscription type and device mode is shown according to an example embodiment. A device/WTRU is capable of supporting Multiple UICCs. The WTRU has a first UICC inserted and has retrieved the Subscription Profile ID from the first UICC. Method 1300 may include triggering 1305 a subscription type determination procedure (e.g. the device determines that a second UICC has been activated or inserted). The WTRU retrieves 1310 the Subscription Profile ID from the second UICC and determines 1315 that the two Subscription Profile IDs are the same, and that the subscriptions are linked, allowing the WTRU to switch, steer, split, or duplicate traffic across two or more UEs.

At step 1320, the WTRU determines a first device mode (e.g. Single Access device mode) based on a Device Mode Policy, and activates a first UICC and first combination of high-layer functionality/low-layer functionality/radio-transceiver functionality. The WTRU triggers a dynamic change to a second device mode (e.g. Multi-UE device mode), based on: e.g. known deployment, neighbor relations, request from the network, request from the RAN node, start/stop of an application. In one option, the WTRU notifies the network about a change in device mode. The WTRU activates 1330 the second UICC and second combination of high-layer functionality/low-layer functionality/radio-transceiver functionality. As with any of the embodiments disclosed herein, steps of method 1300 may be performed in any order, omitted or modified with steps of any other method disclosed herein where suitably feasible.

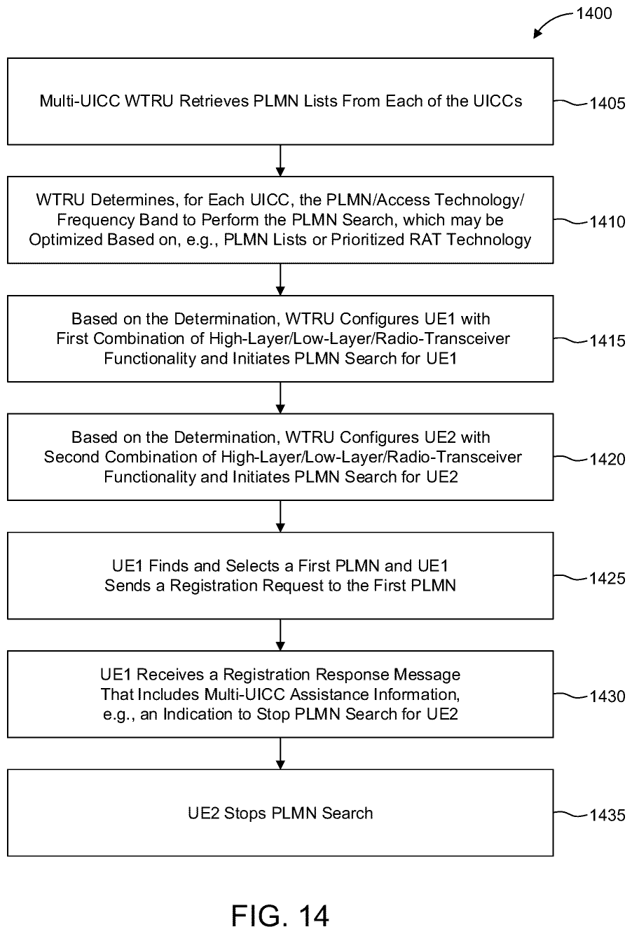

Referring to FIG. 14, a method 1400 for PLMN search/selection for a device/WTRU in Multi-UE device mode is shown according to an example embodiment. A device/WTRU is configured for Multi-UE device mode (i.e. capable of using multiple UEs). Method 1400 includes a Multi-UICC device/WTRU retrieving 1405 the PLMN lists from each of the UICCs and determining 1410, for each UICC, the PLMN/access technology/frequency band to perform the PLMN search. This mechanism is optimized based on, e.g., PLMN lists and prioritized RAT technology as discussed previously. Based on the determination at step 1410, the WTRU configures 1415 UE1 with a first combination of high-layer functionality/low-layer functionality/radio-transceiver functionality, and initiates PLMN search for UE1. Also based on the determination at step 1410, the WTRU configures 1420 UE2 with a second combination of high-layer functionality/low-layer functionality/radio-transceiver functionality, and initiates PLMN search for UE2. At step 1425, UE1 finds and selects a first PLMN, and UE1 sends a registration request to the first PLMN. UE1 receives 1430 a registration response message that includes Multi-UICC assistance information as discussed in previous embodiments (for example, indication to stop PLMN search for UE2). At step 1435, UE2 stops PLMN search. As with any of the embodiments disclosed herein, steps of method 1400 may be performed in any order, omitted or modified with steps of any other method disclosed herein where suitably feasible.

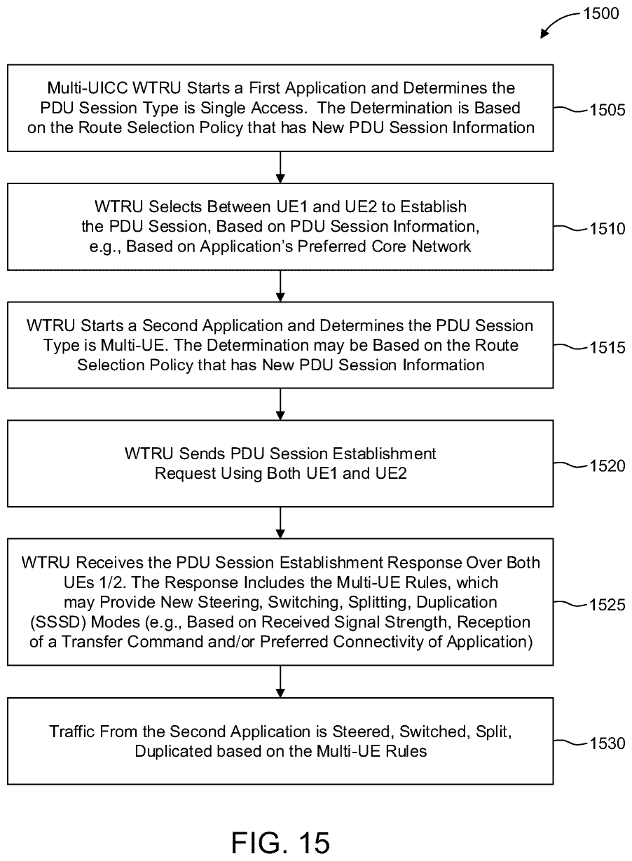

Referring to FIG. 15, a method 1500 for PDU Session Establishment for a device/WTRU in Multi-UE device mode is shown according to an example embodiment. A device/WTRU is configured for Multi-UE device mode (i.e. capable of using multiple UEs). The WTRU is configured to use multiple UEs (UE1 and UE2). It is assumed that UE1 is registered over a first radio access technology (RAT) and UE2 is registered over a second RAT. A Multi-UICC WTRU in method 1500 may start 1505 a first application and determines the PDU session type is Single Access. The determination is based on the route selection policy that has enhanced PDU session information. WTRU selects 1510 between UE1 and UE2 to establish the PDU session, based on PDU session information (for example based on application's preferred core network).

At step 1515, the WTRU starts a second application and determines the PDU session type is Multi-UE. The determination may be based on the route selection policy that has enhanced PDU session information. Next, the WTRU sends 1520 a PDU session establishment request using both UE1 and UE2. At step 1525, the WTRU receives the PDU session establishment response over both UEs. The response includes the Multi-UE rules enhanced to provide new steering, switching, splitting, duplication (SSSD) modes (e.g., rules based on received signal strength, based on reception of a Transfer command, based on preferred connectivity of application). At step 1530, the traffic from the second application is steered, switched, split, and/or duplicated based on the Multi-UE rules.

Additional aspects of this method may include: how the Multi-UE rules are received by the device and the granularity of the Multi-UE rules (per service data flow, per PDU session, per UE); contents of the PDU session information; and new contents of the PDU session establishment request, examples of which have previously been described.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for a wireless transmit receive unit (WTRU) having a first universal integrated circuit card (UICC) and a second UICC, the method comprising:
retrieving subscription profile IDs from the first UICC and the second UICC;
based on the retrieved subscription profile IDs, determining the WTRU supports a multi-UE mode of operation using a first UE (UE1) and a second UE (UE2) of the WTRU to operate for mobility between inter-radio access technology (RAT) networks;
establishing, by the UE1 with a first radio access network (RAN) node, a first user plane (UP) path;
establishing, by the UE1 with the first RAN node, a multi-UE packet data unit (PDU) session having multi-UE mode rules to switch traffic between the inter-RAT networks based on occurrence of a triggering event;
determining the triggering event has occurred and, in response, switching application data traffic from the UE1 using the first UP path, to the UE2 using a second UP path with a second RAN node; and
sending, by the UE2 to the second RAN node, the application data traffic over the second UP path.

2. The method of claim 1, wherein the second RAN node is an inter-RAT RAN node.

3. The method of claim 2, wherein the triggering event comprises one of receiving a transfer command from the first RAN node or a determination by the WTRU that a signal quality of the second RAN node is greater than a signal quality of the first RAN node.

4. The method of claim 1, wherein prior to determining the triggering event has occurred, the method further comprises:
sending, by the UE1 to the first RAN node, a report indicating measurements pertaining to the second RAN node; and
receiving, by the UE2 from the second RAN node, a page or service request to establish the second UP path with the second RAN node.

5. The method of claim 4, wherein switching the application data traffic includes, the UE2 sending to a user plane function (UPF), a message indicating downlink application traffic should be switched to the UE2.

6. The method of claim 1, further comprising:
retrieving public land mobile network (PLMN) lists from the first UICC and the second UICC;
determining, for each UICC, a PLMN, radio access technology and frequency band to perform a PLMN search;
based on the determination, configuring the UE1 with a first combination of higher-layer, lower-layer and radio transceiver functionality and initiating a first PLMN search for the UE1; and
based on the determination, configuring the UE2 with a second combination of higher-layer, lower-layer and radio transceiver functionality and initiating a second PLMN search for the UE2.

7. The method of claim 6, further comprising:
upon finding a first PLMN by the UE1 or the UE2, sending, by the respective UE1 or UE2, a registration request message to the first PLMN; and
receiving, by the respective UE1 or UE2, a registration response message including multi-UICC assistance information.

8. The method of claim 7, wherein the multi-UICC assistance information includes indication of one or more of: the WTRU should stop PLMN search on one specific UE, or an absence, density or location of deployment of one or both of the inter-RAT networks.

9. A wireless transmit receive unit (WTRU) comprising:
a processor;
at least one transceiver operatively coupled to the processor;
a first universal integrated circuit card (UICC) communicatively coupled to the processor; and
a second UICC communicatively coupled to the processor, wherein the processor and the at least one transceiver are configured to:
retrieve subscription profile IDs from the first UICC and the second UICC;
based on the retrieved subscription profile IDs, determine the WTRU supports a multi-UE mode of operation using a first UE (UE1) and a second UE (UE2) of the WTRU to operate for mobility between inter-radio access technology (RAT) networks;
establish, by the UE1 with a first radio access network (RAN) node, a first user plane (UP) path;
establish, by the UE1 with the first RAN node, a multi-UE packet data unit (PDU) session having multi-UE mode rules to switch traffic between the inter-RAT networks based on occurrence of a triggering event;
determine the triggering event has occurred and, in response, switch application data traffic from the UE1 using the first UP path, to the UE2 using a second UP path with a second RAN node; and
send, by the UE2 to the second RAN node, the application data traffic over the second UP path.

10. The WTRU of claim 9, wherein the second RAN node is an inter-RAT RAN node.

11. The WTRU of claim 10, wherein the triggering event comprises one of receiving a transfer command from the first RAN node or a determination by the WTRU that a signal quality of the second RAN node is greater than a signal quality of the first RAN node.

12. The WTRU of claim 9, wherein prior to determining the triggering event has occurred, the processor and the at least one transceiver are further configured to:
send, by the UE1 to the first RAN node, a report indicating measurements pertaining to the second RAN node; and
receive, by the UE2 from the second RAN node, a page or service request to establish the second UP path with the second RAN node.

13. The WTRU of claim 12, wherein switching the application data traffic includes, the UE2 sending to a user plane function (UPF), a message indicating downlink application traffic should be switched to the UE2.

14. The WTRU of claim 9, wherein the processor and the at least one transceiver are further configured to:
retrieve public land mobile network (PLMN) lists from the first UICC and the second UICC;
determine, for each UICC, a PLMN, radio access technology and frequency band to perform a PLMN search;
based on the determination, configure the UE1 with a first combination of higher-layer, lower-layer and radio transceiver functionality and initiate a first PLMN search for the UE1; and
based on the determination, configure the UE2 with a second combination of higher-layer, lower-layer and radio transceiver functionality and initiate a second PLMN search for the UE2.

15. The WTRU of claim 14, wherein the processor and the at least one transceiver are further configured to:
upon finding a first PLMN by the UE1 or the UE2, send, by the respective UE1 or UE2, a registration request message to the first PLMN; and
receive, by the respective UE1 or UE2, a registration response message including multi-UICC assistance information.

16. The WTRU of claim 15, wherein the multi-UICC assistance information includes indication of one or more of: the WTRU should stop PLMN search on one specific UE, or an absence, density or location of deployment of one or both of the inter-RAT networks.

17. A method for a wireless transmit receive unit configured with a first user equipment (UE1) registered over a first radio access technology (RAT) and a second UE (UE2) registered over a second RAT, the method comprising:
starting a first application and determining a single access packet data unit (PDU) session type based on a route selection policy having first PDU session information;
selecting the UE1 to establish a PDU session for the single access PDU session type based on the first PDU session information;
starting a second application and determining a multi-UE PDU session type based on the route selection policy having second PDU session information;
sending, by the UE1 and the UE2, respective PDU session establishment requests;
receiving, by the UE1 and the UE2, respective PDU session establishment responses, wherein the PDU session establishment responses by the UE1 and the UE2 include multi-UE rules to provide one or more of steering, switching, splitting or duplication (SSSD) modes; and
wherein traffic for the second application is one or more of steered, switched, split or duplicated based on the multi-UE rules.

18. The method of claim 17, wherein the multi-UE rules relate to a granularity of per one of service data flow, per PDU session or per UE.

19. The method of claim 17, wherein the SSSD modes are determined based on at least one of received signal strength of the second RAT radio access network (RAN) node, reception of a transfer command from a RAN node of the first RAT or a preferred connectivity indicated by the second application.

20. The method of claim 17, wherein the first RAT is a legacy radio access network (RAN) and wherein the second RAT is a next-generation RAN.
